(19) United States
(12) Patent Application Publication
(10) Pub. No.: US 2015/0000534 A1
(43) Pub. Date: Jan. 1, 2015

(54) JAM AND JELLY MAKER

(71) Applicant: Hearthmark, LLC, Daleville, IN (US)

(72) Inventors: Scott Hager, McCordsville, IN (US); Gokce Kayalar, Shenzhen (CN)

(73) Assignee: HEARTHMARK, LLC, Daleville, IN (US)

(21) Appl. No.: 14/372,918

(22) PCT Filed: Feb. 22, 2013
(86) PCT No.: PCT/US13/27368

§ 371 Date: Jul. 17, 2014

Related U.S. Application Data
(60) Provisional application No. 61/601,955, filed on Feb. 22, 2012.

(51) Int. Cl. A47J 27/00; A23L 1/06; A47J 36/16

(52) U.S. Cl. CPC A47J 27/004; A47J 36/165; A23L 1/06
USPC 99/328; 99/327

(57) ABSTRACT

An automatic jam and jelly maker has a base assembly having a motor, a heater subassembly, a user interface, and a control module. The automatic jam and jelly maker also has a pot assembly removably receivable on the base assembly, a stirrer assembly removably receivable in the pot, a colander removably receivable in the pot, and a lid assembly removably receivable on a lip retaining lip of the colander. The automatic jam and jelly maker has a cook mode used to make jam or jelly in which the stirrer assembly is received in the pot and rotated and ingredients are heated. The cook mode includes a jam mode and a jelly mode. The automatic jam and jelly maker may also include a steam mode used to extract juice from fruit.

### FIELD

The present disclosure relates to jam and jelly makers.

### BACKGROUND

This section provides background information related to the present disclosure which is not necessarily prior art.

Jam can be made with both fruit juice and pieces of fruit or pieces of vegetables, although some cookbooks define jam as cooked and gelled fruit or vegetable puree. The term “jam” also refers to a product made with whole fruit, cut into pieces or crushed.

Jelly is a clear or translucent fruit spread made from sweetened fruit or vegetable juice and set using naturally occurring pectin. Additional pectin may be added where the original fruit does not supply enough.

When making jams and jellies a great deal of time, effort and experience is required to achieve a good home made batch, every time. What ingredients to use, how much to add and when to add, the temperature and the duration of cook are examples of what a person using conventional methods to make a jam or jelly needs to know. An appliance that automates this process and enhances the experience of jam and jelly making by removing a cook from a hot stove and from stirring boiling hot foods as traditionally required would be greatly appreciated by those presently using conventional methods to make jams and jellies.

Some bread machines have a jam feature or setting that will automatically heat and stir ingredients for making jam. However, such devices are first and foremost bread machines with the addition of a jam making feature. The quantity of jam produced is small and the stirrer is generally inadequate leaving portions burned or inadequately stirred.

### SUMMARY

This section provides a general summary of the disclosure, and is not a comprehensive disclosure of its full scope or all of its features.

An automatic jam and jelly maker in accordance with an aspect of the present disclosure has a base assembly having a motor, a heater subassembly, a user interface, and a control module. The automatic jam and jelly maker also includes a pot assembly removably receivable on the base assembly with a bottom of a pot of the pot assembly resting on the heater plate with the pot assembly is received on the base assembly; a stirrer assembly removably receivable in the pot of the pot assembly; and a lid assembly removably receivable on the pot. The automatic jam and jelly maker has a cook mode in which the stirrer assembly is received in the pot. When jam and jelly maker is in the cook mode, the control module energizing the motor and heater subassembly to rotate the stirrer assembly to stir ingredients in the pot and to heat the ingredients in the pot for a period of time based on a time entered by the user via the user interface.

In an aspect, the cook mode includes a jam mode and also a jelly mode, the jam and jelly modes selectable by the user via the user interface.

In accordance with an aspect of the present disclosure, the heater assembly includes a heater plate and a heater coil disposed beneath the heater plate and the period of time entered by the user when the automatic jam and jelly maker is in the cook mode includes a cook cycle, a non-heated agitation cycle following the cook cycle, and a cool down cycle after the non-heated agitation cycle. During the cook cycle the motor is turned on by the control module and rotates to rotate the stirrer assembly to stir the ingredients in the pot with the blades of the stirrer assembly rotating through the ingredients and the heater coil is energized by the control module to heat the ingredients in the pot to a predetermined temperature and cycled thereafter to regulate a temperature of the heater coil and thus regulate a temperature of the heater plate. During the non-heated agitation cycle, the heater coil is de-energized by the control module with the motor remaining turned on by the control module to continue stirring the ingredients in the pot with the stirrer assembly. During the cool down cycle, the heater coil and motor are de-energized and starting of the cook mode anew is disabled until the cool down cycle is over, and the cool down cycle lasts until a temperature sensor of the base assembly abutting a bottom of the pot senses that a temperature has fallen below a predetermined high temperature limit.

In accordance with an aspect of the present disclosure, the base assembly includes a temperature sensor extending through the heater plate and abutting a bottom of the pot. The control module is responsive to the temperature sensor sensing that the predetermined temperature has been reached and then cycling the heater coil on and off to regulate the temperature of the heater coil.

In accordance with an aspect of the present disclosure, the control module when the automatic jam and jelly maker is in the cook mode alerts the user via the user interface to add sugar to the ingredients in the pot at a predetermined time after the cook cycle has started. In accordance with an aspect of the present disclosure, the user interface sounds a beep and flashes visually to alert the user to add sugar and the predetermined time at which the control module alerts the user to add sugar is about four minutes after the cook cycle has started.

In accordance with an aspect of the present disclosure, the stirrer assembly includes a central hub with a plurality of stirrer blades extending radially outwardly therefrom, the stirrer blades having a double airfoil helix geometry. In accordance with an aspect of the present disclosure, the bottom of the pot of the pot assembly has a convex geometry that works with gravity to pull a bulk of the ingredients in the pot toward a lowest point in the pot at an outer edge of the pot. In accordance with an aspect of the present disclosure, when the stirrer assembly is rotating thus rotating the stirrer blades through the ingredients in the pot, the double airfoil helix geometry of the stirrer blades draws upwardly ingredients near a bottom of the pot, turns the ingredients over and pulls the ingredients toward a center hub of the stirrer assembly.

In accordance with an aspect of the present disclosure, the central hub of the stirrer assembly includes a drive support post having a lower hollow central bore in which an upper portion of a drive shaft is received, a lower portion of the drive shaft received in an upper portion of a motor shaft sleeve of the base assembly, and a lower portion of the motor shaft sleeve secured to a motor shaft of a motor of the base assembly. In accordance with an aspect of the present disclosure, the upper portion of the drive shaft is knurled and the lower portion of the drive shaft is keyed to correspond to a corresponding key of an upper portion of the motor shaft sleeve, the upper portion of the motor shaft sleeve formed with chamfer allowing a loose fit with the drive shaft until the stirrer assembly is fully in place in the pot of the pot assembly.

In accordance with an aspect of the present disclosure, the lid assembly includes an annular cover and a lid ring extending around an outer circumference of the cover, the lid ring having a sidewall extending downwardly from the cover, the sidewall of the lid ring having a plurality of vent holes therein. In accordance with an aspect of the present disclosure, the lid assembly includes a lid knob secured to a center of the cover, the lid knob having an inverse taper geometry.

In accordance with an aspect of the present disclosure, the pot of the pot assembly includes a pot coupler secured to an underside of the bottom of the pot, the base assembly including a base coupler disposed at a center of the base assembly, and the pot coupler and base coupler self-align with each other when full seated with each other. In accordance with an aspect of the present disclosure, the pot coupler and base coupler have alignment features having geometries that compensate for horizontal and angular misalignment when the pot is being placed on the base assembly to align the pot on the base assembly. In accordance with an aspect of the present disclosure, the pot coupler is disk shaped and the base coupler includes a cylindrical hub, the alignment features include the pot coupler having ear slots on opposed sides of a central annular bore and the base coupler having opposed ears at an upper end of the cylindrical hub, wherein the opposed ears of the base coupler are received in the ear slots of the pot coupler when the pot is received on the base assembly and coact with the ear slots to align the pot on the base assembly.

In an aspect of the present disclosure, the pot assembly includes a center post cone extending upwardly from a center of the pot of the pot assembly. In an aspect of the present disclosure, the pot assembly includes a center post cone locating ring fastened into the center post cone at a top thereof, the center pot cone locating ring facilitating alignment of a stirrer drive shaft support post of the stirrer assembly as the stirrer assembly is placed in the pot of the pot assembly and prevents the stirrer assembly from contacting the center post cone during rotation of the stirrer assembly, the center post cone locating ring also providing a mating surface for the colander when the colander is received in the pot.

In an aspect of the present disclosure, the center post cone of the pot assembly has a center post cone base flange secured to a pot base flange with an elastomeric gasket disposed therebetween. In an aspect, the elastomeric gasket is cup shaped having a central portion with concentric annular ribs on top and bottom surfaces of the central portion. The central portion has a central bore. In an aspect, the central portion includes a deflection portion surrounding the central bore that is configured to deflect upwardly outwardly when the center post cone is inserted through the central bore. In an aspect, a surface of the deflection portion that contacts the center post cone includes a plurality of ribs extending therearound and projecting inwardly therefrom. In an aspect, the gasket includes a plurality of rivet holes with ribs extending around perimeters of the rivet holes.

In an aspect of the present disclosure, the pot includes a pair of opposed long reach handles extending outwardly therefrom.

In an aspect of the present disclosure, the pot has a frusto-conical geometry with a sidewall extending upwardly and outwardly from a convex bottom. In an aspect of the present disclosure, a heater plate of the base assembly has a geometry conforming to a geometry of a bottom of the pot.

In an aspect of the present disclosure, the base assembly includes a reflector plate disposed below the heater coil.

In an aspect of the present disclosure, the base assembly includes a base having a base plate, the base plate having a plurality of vents therein.

In accordance with an aspect of the present disclosure, the jam and jelly maker further includes a steam mode in which the colander is received in the pot and a lid assembly is received on a retaining lip of the colander and the control module energizing the heater subassembly to heat ingredients in the pot for a period of time based on a time entered by the user via the user interface. In accordance with an aspect of the present disclosure, the steam mode is selectable by a user via the user interface.

In accordance with an aspect of the present disclosure, the colander has a base having a plurality of vent holes therein. In accordance with an aspect of the present disclosure, the colander has a sidewall extending upwardly and outwardly from the base of the colander, the sidewall of the colander having a lid retainer lip extending upwardly and outwardly around a periphery of a top of the sidewall of the colander, the lid retainer lip of the sidewall of the colander having a plurality of lid vent ribs spaced therearound. In accordance with an aspect of the present disclosure the sidewall of the colander includes a plurality of vertical vent slots therein spaced around the sidewall of the colander. In accordance with an aspect of the present disclosure, the colander includes a pair of opposed long reach handles extending outwardly from a top edge of the sidewall of the colander. In accordance with an aspect of the present disclosure, the colander includes a pot center post cone cover shaped to conform to a center post cone of the pot assembly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of an automatic jam and jelly maker in accordance with an aspect of the present disclosure;

FIG. 2 is an exploded view of the automatic jam and jelly maker of FIG. 1;

FIG. 3 is a perspective view of a lid assembly of the automatic jam and jelly maker of FIG. 1;

FIG. 4 is a section view of the lid assembly of the automatic jam and jelly maker of FIG. 3 taken along the line 4-4 of FIG. 3;

FIG. 5 is a perspective view of a stirrer assembly of the automatic jam and jelly maker of FIG. 1;

FIG. 6 is a section view of the stirrer assembly of FIG. 5 taken along the line 6-6 of FIG. 5;

FIG. 7 is a perspective view of a top portion of a drive shaft of the stirrer assembly of FIG. 5;

FIG. 8 is an exploded view of a pot assembly of the jam and jelly maker of FIG. 1;

FIG. 9 is a perspective view of the pot assembly of FIG. 8;

FIG. 10 is a front view of a base assembly of the jam and jelly maker of FIG. 1;

FIG. 11 is a side section view of the jam and jelly maker in accordance with an aspect of the present disclosure with the pot assembly and stirrer assembly in place;

FIG. 12 is a perspective view of the base assembly of FIG. 10 with certain components removed;

FIG. 13 is a perspective view of the base assembly with the pot assembly in place of the jam and jelly maker in accordance with an aspect of the present disclosure with an exploded view of a user interface of the base assembly;

FIG. 14 is a perspective view of a colander of the automatic jam and jelly maker of FIG. 1;

FIG. 15 is a simplified schematic showing the interconnection of electrical and electronic components of the base assembly of FIG. 10;

FIG. 16 is a flow chart of a control program for a Jam cook mode of the jam and jelly maker of FIG. 1;

FIG. 17 is a flow chart of a control program for a steam mode of the jam and jelly maker of FIG. 1;

FIG. 18 illustrates flow patterns in a mix of ingredients in the pot of the pot assembly when the stirrer assembly of the automatic jam and jelly maker of FIG. 1 is rotating when the automatic jam and jelly maker of FIG. 1 is being used to make jam or jelly; and

FIGS. 19A and 19 B are top and bottom perspective views of a gasket of the pot assembly of FIG. 8.

Corresponding reference numerals indicate corresponding parts throughout the several views of the drawings.

### DETAILED DESCRIPTION

Example embodiments will now be described more fully with reference to the accompanying drawings.

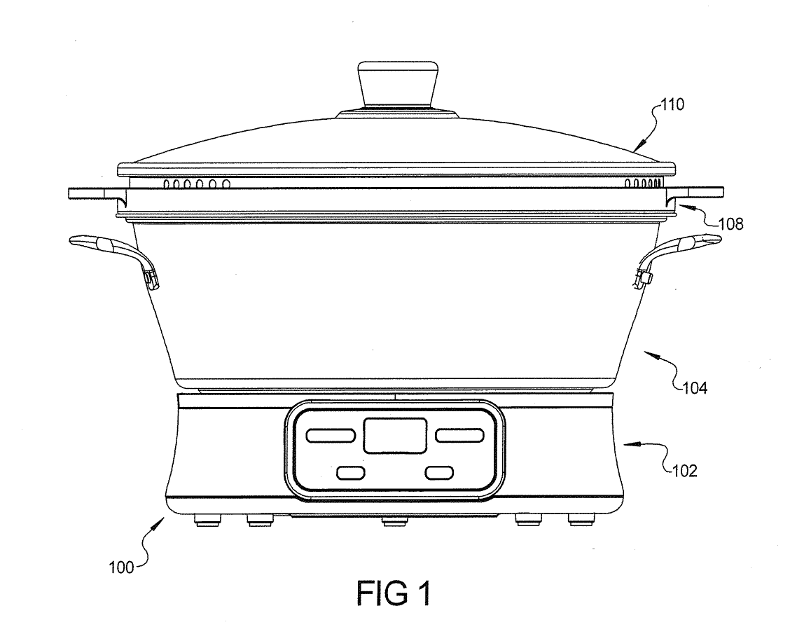

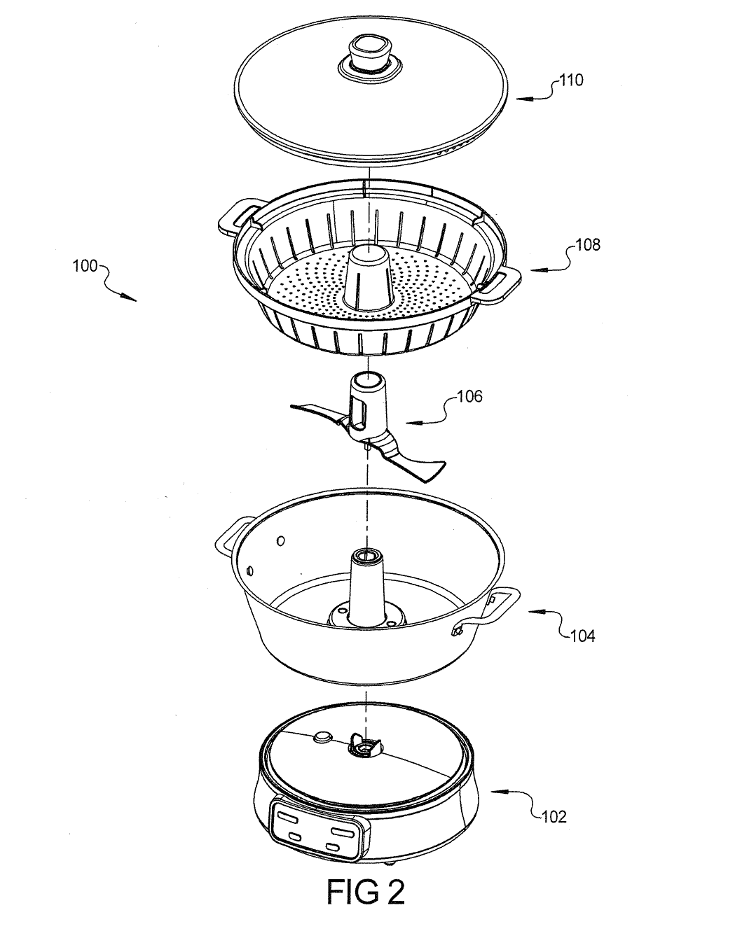

FIG. 1 shows a front view an automatic jam and jelly maker 100 in accordance with an aspect of the present disclosure and FIG. 2 shows an exploded view of the jam and jelly maker 100. Jam and jelly maker 100 includes a base assembly 102, a pot assembly 104, a stirrer assembly 106 (FIG. 2), a colander 108 and a lid assembly 110, all of which are described in more detail below.

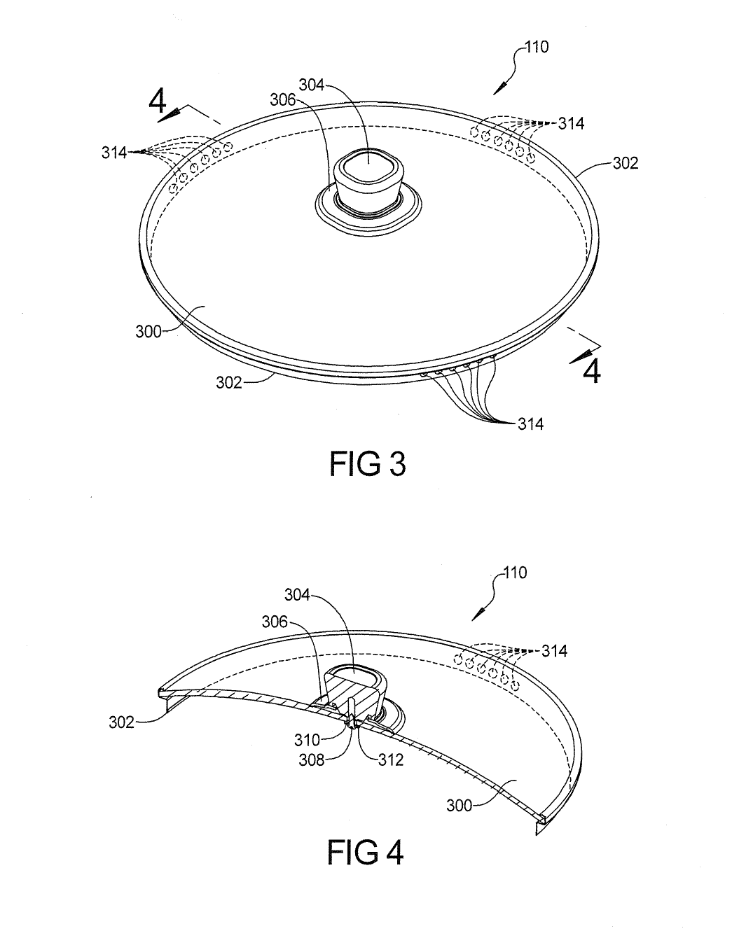

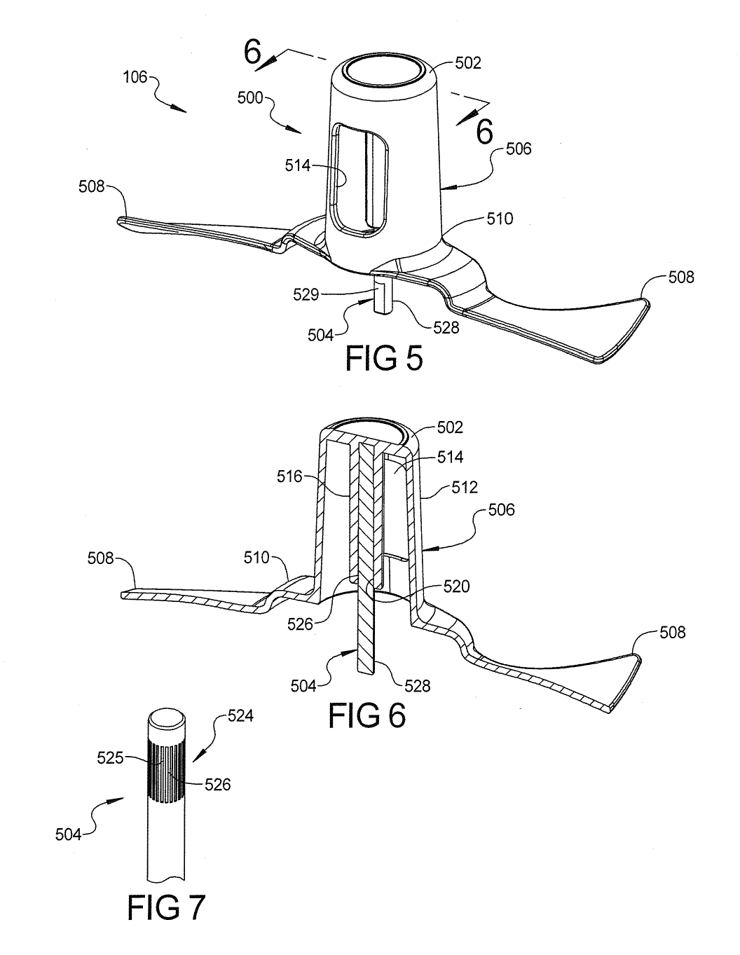

With reference to FIGS. 3 and 4, lid assembly 110 includes a convex cover 300, a id ring 302 (which may also be referred to as a lip ring), a lid knob 304, a lid knob flange 306, a knob fastener 308 (FIG. 4), a knob fastener washer 310 (FIG. 4) and a knob fastener seal 312 (FIG. 4). Cover 300 may illustratively be made from tempered glass to resist thermo shock. Lid ring 302 includes a plurality of vent holes 314 and may illustratively be made of stainless steel. Lid knob 304 may illustratively be an ergonomically designed knob with an inverse taper geometry that prevents it from slipping from a user's hand. Lid knob 304 may illustratively be a molded plastic molded part. Lid knob flange 306 spreads the surface load of lid knob 304 to prevent isolated loading and fracturing of cover 300. Knob fastener 308, which may illustratively be a screw or bolt, fastens lid knob 304 to cover 400. Lid knob 304 may in an embodiment have a threaded bore (not shown) into which knob fastener 308 is threadably tightened. Knob fastener seal 312 may illustratively be disposed between knob fastener washer 310 and a bottom surface 314 of cover 300 and may be a silicon rubber seal. Knob fastener seal 312 prevents steam and water from escaping/penetrating through cover 300 where lid knob 304 is attached to cover 300 by knob fastener 308.

With reference to FIG. 5, stirrer assembly 106 includes a stirrer hub and blade body 500, stirrer blade cover 502 and drive shaft 504. Stirrer hub and blade body 500 includes central hub 506 having a plurality of radially outwardly extending blades 508 extending from a lower end 510 of hub 506. In the illustrative embodiment shown in FIG. 5, hub 506 has two opposed radially outwardly extending blades 508. It should be understood that blade body 508 could have more than two blades 510. In the embodiment shown in FIG. 5, opposed radially outwardly extending blades 510 have a double airfoil helix geometry. Hub 506 includes a cylindrical outer wall 512. Cylindrical outer wall 512 includes a plurality of vent openings 514, only one of which is shown in FIG. 5. Hub 506 includes stirrer drive support post 516 at a center of hub 506. Stirrer hub and blade body 500 is illustratively a plastic molded part.

Stirrer blade cover 502 may illustratively be a disk shaped part, and illustratively a plastic molded part. Stirrer blade cover 502 is secured atop stirrer hub and blade body 502, such as by sonic welding, to prevent food and other particulates from entering an upper hollow central bore 518 within stirrer drive support post 516.

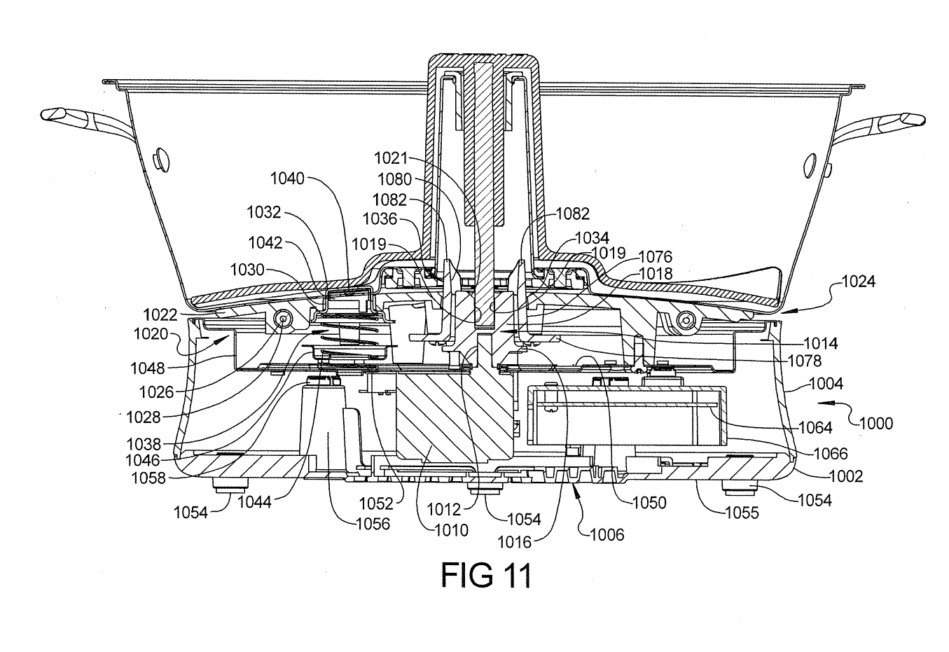

Drive shaft 504 is secured in a lower hollow central bore 520 within stirrer drive support post 516. Lower hollow central bore 520 is separated from upper hollow central bore 518 by a wall 522. Drive shaft 504 may illustratively be insert molded in lower hollow central bore 520 of stirrer drive support post 516, and may illustratively be a stainless steel shaft. As best shown in FIG. 7, an upper portion 524 of drive shaft 504 may illustratively include features 525 formed in an outer surface 526 to grip the plastic molded around it when drive shaft 504 is insert molded. For example, outer surface 526 of upper portion 524 of drive shaft may be knurled. It should be understood that features other than knurling outer surface of upper portion 524 could be used. A lower portion 528 of drive shaft 504 is keyed to engage a corresponding key of motor shaft sleeve 1014 (FIG. 11) to provide a rigid connection between motor 1010 (FIG. 11) and stirrer hub and blade body when sitter hub and blade body is in place in jam and jelly maker 100. Illustratively, lower portion 528 is keyed with one or more machined flats 529 (only one of which is shown in FIG. 5).

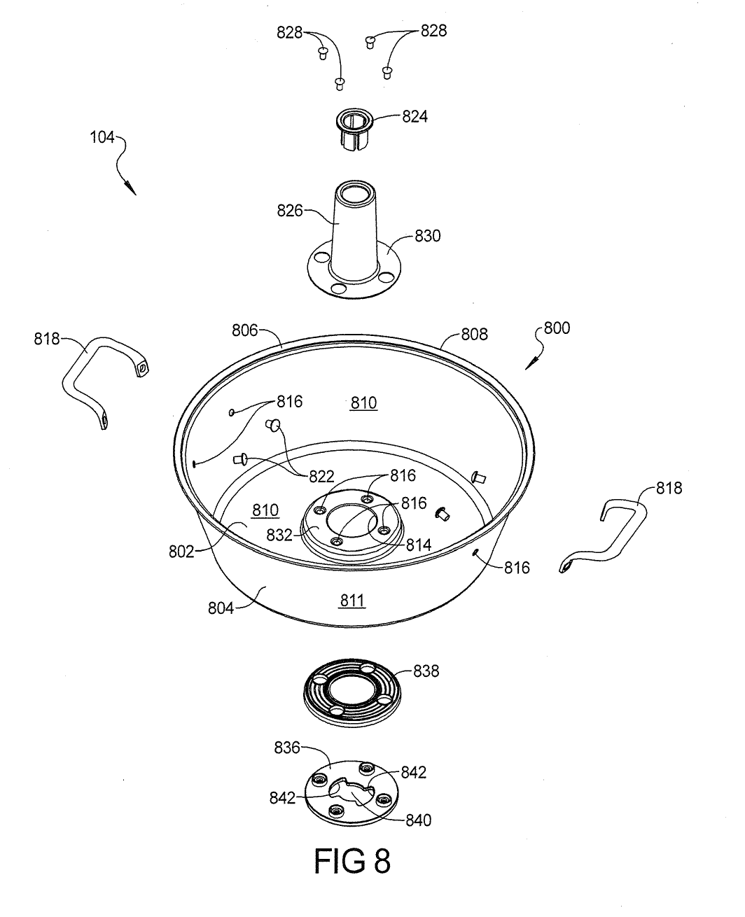

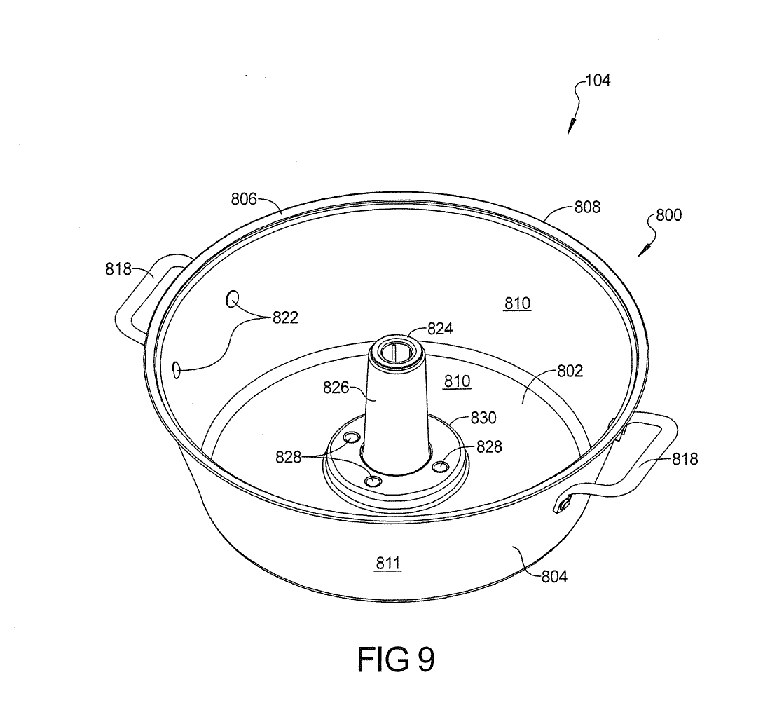

With reference to FIGS. 8 and 9, pot assembly 104 includes a pot 800 having a convex bottom 802 (when viewed from the perspective of looking into pot 800 from above), a sidewall 804 extending upwardly and outwardly from base 802 and an integrated lid nesting lip 806 extending around an upper edge 808 of sidewall 804. Sidewall 804 may illustratively have a truncated conical geometry. The convex geometry of pot bottom 802 improves strength, manufacturability and in conjunction with stirrer assembly 106, improves agitation. A diameter of pot 800 may illustratively be smaller than a diameter of pot at upper edge 808 which helps promote evaporation of liquids when making jams or jellies. Illustratively, an interior surface 810 of pot 600 is coated with a non-stick material, such as Teflon, PTFE or other non-stick material. An exterior surface 811 of pot 600 may illustratively be coated with a high temperature paint or coating. Pot 800 may drawn from aluminized carbon steel.

Pot assembly 104 also includes a center post cone receiving hole 814, a plurality (illustratively four) of center post cone rivet holes 816 spaced (illustratively equidistantly) around center post cone receiving hole 814, and a plurality of handle rivet holes 816 in opposite sides of sidewall 804 beneath upper edge 808. In the embodiment shown in FIGS. 8 and 9, there are illustratively two handle rivet holes 816 per side as pot assembly 104 includes two handles 818. Handles 818 are affixed on opposite sides of sidewall 804 by handle rivets 822. Handles 820 may illustratively be long reach handles and affixed to pot 800 at locations (such as immediately beneath upper edge 808) to keep them cool to touch during any given heat cycle of jam and jelly maker 100. As used herein, a long reach handle is a handle that extends outwardly from a heat source a sufficient distance to limit accumulative heat build-up. The distance of this outward extension of the long reach handle also increases confidence for user mobility.

Pot assembly 104 further includes a center post cone locating ring 824 fastened into a center post cone 826. Center post cone locating ring 824 may illustratively be a plastic molded part and snap fastened into the center post cone 826. Center post locating ring 824 improves the alignment of the stirrer drive shaft support post 516 as stirrer assembly 106 is lowered into pot 800 and assembled with motor shaft sleeve 1014 during setup for jam or jelly making. The center post cone locating ring 824 prevents the stirrer assembly 106 from contacting center post cone 826 and damaging the stirrer drive shaft support post 516 when stirrer assembly 106 is rotating. Center post locating ring 824 also provides a mating surface for colander assembly 108 when colander assembly 108 is disposed in pot 800. This reduces steam creep into the pot center post cone which could otherwise land atop the heater plate and drive assembly.

Center post cone rivets 828 are received in center post cone rivet holes 816 and secure center a center post cone base flange 830 of center post cone 826 to a pot base flange 832 of pot base 802 at a central portion 834 thereof and also secure a pot coupler 836 to pot base flange 832. These rivets 828 provide a solid engagement between the pot bottom 802 and center post cone 826 to prevent any movement from occurring. The rivets are fastened tightly and uniformly to the pot base flange 832 and center post cone base flange 830 for the successful sealing shut off of liquids via a silicon gasket 838 sandwiched between center post cone base flange 830, pot base coupler 836 and pot base flange 832.

Center post cone 826 may illustratively be a drawn aluminum component. Its purpose includes preventing liquids from seeping down into the base assembly 102, providing access, support and alignment to the stirrer assembly 106 and its respective drive components and providing support to the colander assembly 106.

Silicon gasket 838 may illustratively be made of a high temperature food grade silicon an may have a black coloration to protect against staining. Silicon gasket 838 prevents liquids from entering through a seam between center post cone base flange 830 and pot base flange 832.

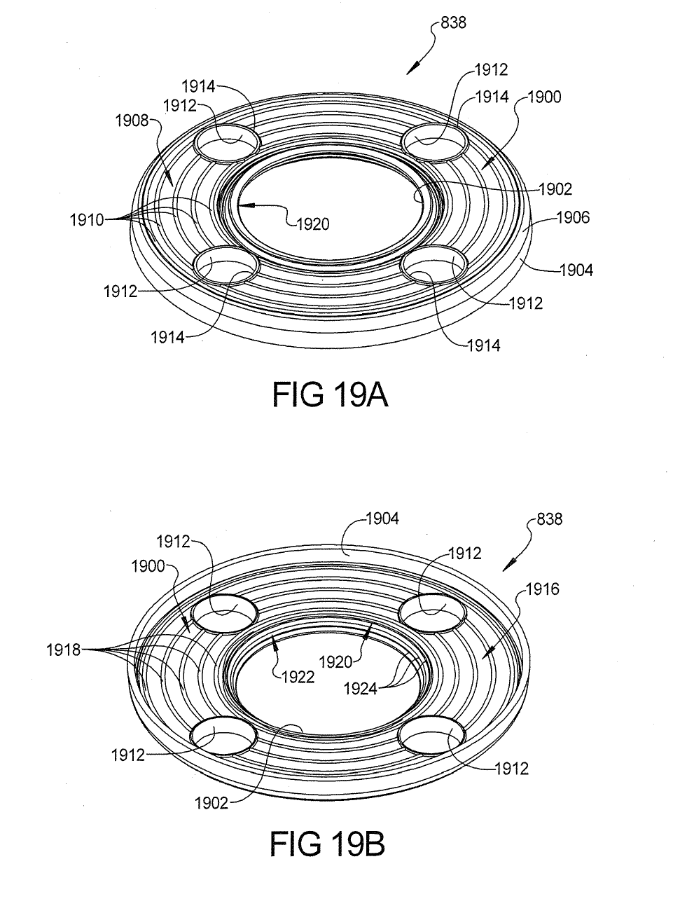

FIGS. 19A and 19B are top and bottom perspective views of gasket 838 showing gasket 838 in more detail. Gasket 838 is generally cup shaped having a central portion 1900 with a central bore 1902 therein and a flange portion 1904 extending downwardly from a periphery 1906 of central portion 1900. A top surface 1908 of central portion 1900 has a plurality of annular concentric ribs 1910 extending upwardly therefrom, a plurality of rivet holes 1912 extending therethrough, an upwardly projecting rib 1914 around the perimeter of each rivet hole 1912. A bottom surface 1916 (FIG. 19B) of central portion 1900 has a plurality of annular concentric ribs 1918 projecting downwardly therefrom.

The annular concentric ribs 1910 and 1918 projecting from the respective top and bottom surfaces 1908 and 1916 of central portion 1900 prevent liquids from creeping in and around the center post cone base flange 830 and the pot base flange 832 and down onto heater plate 1022 of base assembly 102. Gasket 838 is compressed between center post cone base flange 830 and pot base flange 832 and held in place with rivets 828 that extend through rivet holes 1912. Ribs 1914 around the perimeters of rivet holes 1912 prevent the channeling of liquids into rivet holes 1912. In an aspect, a food grade glue or other sealant may additionally be used on one or more of the surfaces of gasket 838 to provide further prevention of leaks.

The central portion 1900 includes a deflection portion 1920 surrounding central bore 1902 that is configured to deflect upwardly and outwardly around the center post cone when center post cone 826 is inserted through central bore 1902. A surface 1922 (FIG. 19B) of deflection portion 1920 that contacts center post cone 826 includes a plurality of ribs 1924 extending therearound and projecting inwardly therefrom that create plugs that seal off liquid flow. This deflection creates a compression effect or collar around center post cone 826, squeezing the silicon material of gasket 838 against center post cone 826 to prevent liquids from creeping in and around the center post cone 826 and dropping down onto heater plate 1022 of base assembly 102.

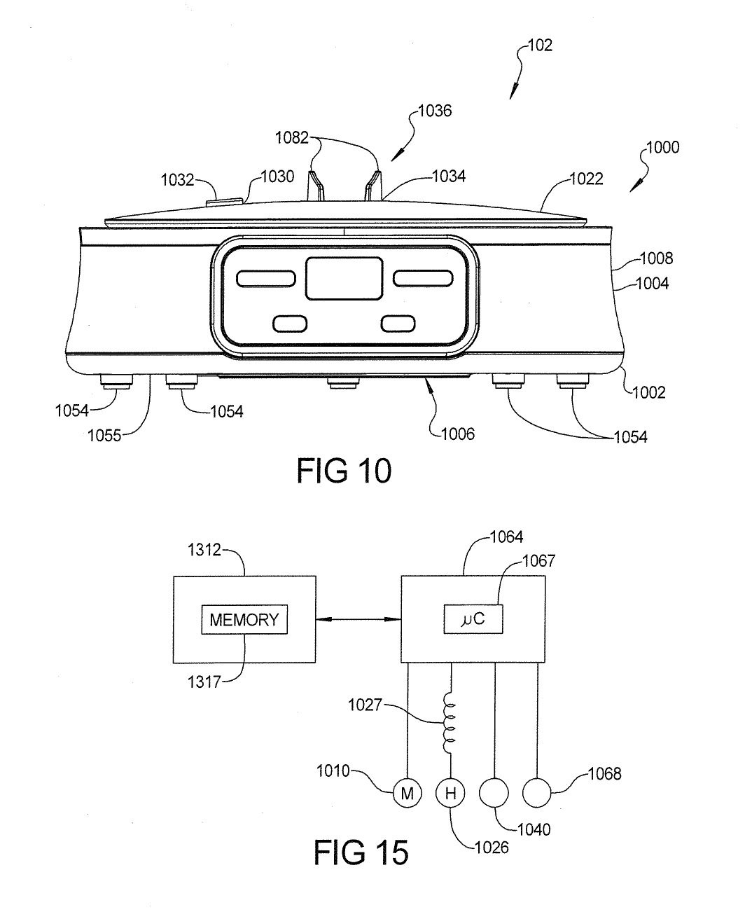

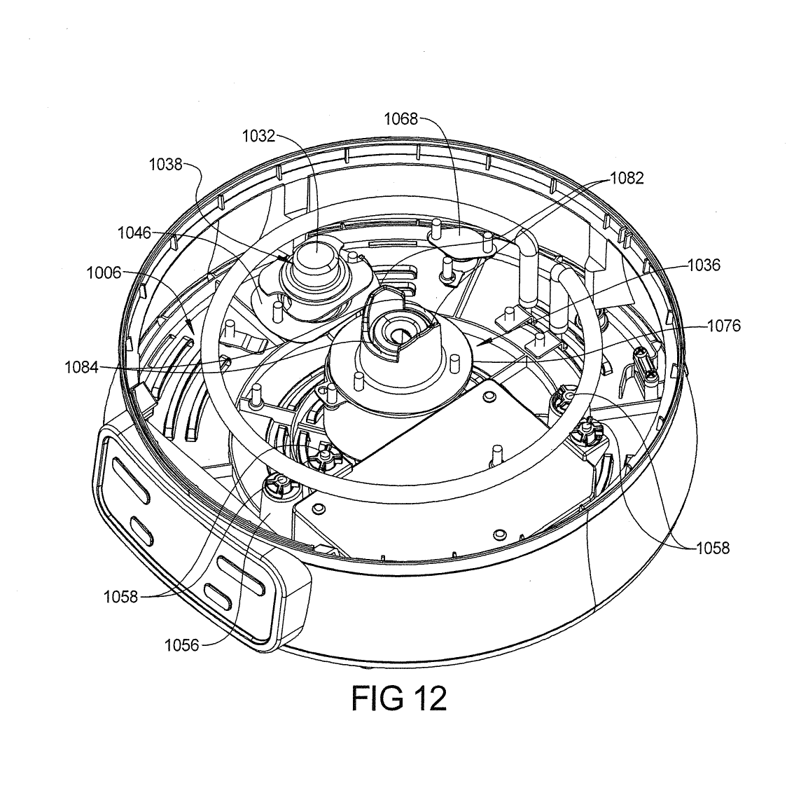

Pot coupler 834 may illustratively be a cast aluminum part. Pot coupler 836 has a central annular bore 840 opening on opposite sides thereof to generally ear shaped slots 842 that extend radially from central annular bore 840 on opposite sides thereof. The geometry of pot coupler 836 in conjunction with the geometry of a base coupler 1036 (FIGS. 10-12) of base assembly 102 helps the user easily align pot 800 onto base assembly 102. When lowering pot 800 onto base assembly 102, pot 800 can be misaligned laterally as well as angularly and pot coupler 836 coacting with base coupler 1036 brings pot 800 into alignment with base assembly 102. Once fully seated, pot coupler 836 and base coupler 874 self-align to prevent side to side and rotational movement of pot 800 on base assembly 102 during operation of jam and jelly maker 100.

With reference to FIGS. 10-13, base assembly 102 includes a base 1000 having an annular base plate 1002 and a generally cylindrical base housing 1004. Base plate 1002 is a bottom of base assembly 102 with base housing 1004 mounted to base plate 1002 and extending upwardly therefrom. Base plate 1002 and base housing 1004 may illustratively be plastic molded parts. Base plate 1002 includes louvers 1006 to vent heat emitted by the electronic and other heat emitting components of jam and jelly maker 100 that are included in base assembly 102. Louvers 1006 also allow any liquid that may accidently enter base 800 to escape. Louvers 1006 may be formed around in base plate 1002 when base plate 1002 is molded.

Base assembly 102 includes a motor 1010 (FIG. 11) mounted in base 1000 at a central portion thereof. Motor 810 may illustratively be configured to operate at 8 RPM and configured to operate synchronously (clockwise and counterclockwise) to prevent overloading and burnout. For example, if motor 1010 is in a high torque situation for which it cannot turn properly, it will automatically reverse its direction (i.e. counterclockwise to clockwise) to help release the jam or build up. The reversal process is normally effective at clearing whatever buildup has occurred. Motor 1010 is coupled to a control module 1064 that controls the operation of motor 1010. It should be understood that motor 1010 can operate at speeds other than 8 RPM.

Motor 1010 includes an upwardly extending motor shaft 1012 (which is the shaft of the rotor of motor 810). A motor shaft sleeve 1014 couples motor shaft 1012 to drive shaft 504 (FIG. 5) of stirrer assembly 106. A lower portion 1016 of motor shaft sleeve 1014 receives and is secured to motor shaft 1012 and an upper portion 1018 of motor shaft sleeve 1014 receives lower portion 528 (FIG. 5) of drive shaft 504 of stirrer assembly 106. Upper portion 1018 of motor shaft sleeve 1014 is keyed to correspond to the key of lower portion 528 of drive shaft 504 of stirrer assembly 106. For example, where lower portion 528 of drive shaft 504 of stirrer assembly 106 is machined with flats, upper portion 1018 is formed with corresponding flats 1019. Upper portion 1018 of motor shaft sleeve 1014 is formed with a large chamfer 1021 allowing a loose fit with drive shaft 504 of stirrer assembly 106 until stirrer assembly 106 is fully in place in jam and jelly maker 100. Motor shaft sleeve 1014 is thus designed to accept a great deal of misalignment with drive shaft 504 of stirrer assembly 106 when stirrer assembly 106 is being put in place in jam and jelly maker 100. Motor shaft sleeve 1014 may illustratively be made of high temperature Bakelite.

Base assembly 102 further includes a heater subassembly 1020. Heater subassembly 1020 includes a heater plate 1022 disposed at a top 1024 of base 1000, a heater coil 1026 and a heater core 1028 insert molded in heater plate 1022. Heater plate 1022 is formed to match the convex shape of pot base 802 and illustratively includes small raised rib features (not shown), which may be produced when forming heater plate 1022 such as by CNC machining, that increase the surface area of heater plate 1022 and its thermal conductivity. Heater plate 1022 may illustratively be coated with a high temperature paint.

Heater plate 1022 includes an off center through hole 1030 in which an NTC sensor cover 1032 is received and a central through hole 1034 through which a base coupler 1036 and motor shaft 1012 extend. An outer diameter of heater plate 1022 may illustratively be smaller than an outer diameter of pot bottom 1002. This helps prevents burning any food that may be caught at the outer edges of a bottom of pot 1000 and that may not get stirred at the bottommost part of pot 1000.

Base assembly 102 includes an NTC (negative temperature coefficient) sensor sub-assembly 1038 that includes NTC cover 1032, an NTC sensor 1040, an NTC-NTC fit plate 1042 on which NTC sensor 1040 is disposed, an NTC case spring 1044, and an NTC bracket 1046 on which NTC case spring 1044 is disposed. As best shown in FIG. 11, NTC cover 1032 abuts pot base 802 when pot 800 is received on base 800. Spring 1044 urges NTC cover 1032 up against pot base 802 so that it is flush against pot base 802. NTC sensor 1040 is coupled to control module 1064, which may illustratively comprise a printed circuit board assembly. NTC sensor 1040 maintains and controls a preset temperature via control module 1064. Control module 1064, in response to the temperature sensed by NTC sensor 1040, turns heater coil 1026 on and off to maintain the preset temperature once the preset temperature is reached. For example, the preset temperature may be pre-set to a temperature from 100° C. to 165° C., and may illustratively be 123° C. Once the pre-set temperature is detected by NTC sensor 1040, it relays a signal to control module 1064 which then turns heater coil 106 on and off to regulate temperature. In this regard, control module 1064 may turn a relay (shown representatively by coil 1027 in FIG. 15) on and off to turn power to heater coil 1026 on and off. NTC sensor 1040 also prevents heater coil 1026 from getting too hot, such as may occur when pot 800 runs dry. Additionally, if a pot is not in place, the heater coil 1026 and a reflector plate 1048 (discussed below) may get sufficiently hot so that a thermostat 1068 cuts power off to heater coil 1026. Thermostat 1068 may illustratively abut reflector plate 1048 and may be disposed adjacent heather coil 1026.

Base assembly 102 further includes a reflector plate 1048 disposed beneath heater plate 1022 to reflect heat from heater plate 1022 to protect electrical components of base assembly 102 mounted in base 100 below reflector plate 1048. Reflector plate 1048 may illustratively be an annular plate having an outside diameter greater than the outside diameter of heater plate 1022, and may illustratively have an outside diameter equal to an inside diameter of base housing 1004 thus covering a portion of base 1000 beneath heater plate 1022. Reflector plate 1048 may illustratively be a carbon steel plate and coated with high temperature paint. Reflector plate 1048 also acts to prevent food and liquids from reaching electrically live components mounted in base 1000. Reflector plate 1048 illustratively has recessed gullies 1050 and drain holes 1052 therein to channel away any liquid that reaches reflector plate 1048. It should also be understood that a number of components of base assembly 102 may be fastened to reflector plate 848.

Base plate 1002 further includes a plurality of rubber feet 1054 mounted on a bottom 1055 of base plate 1002. Rubber feet 1054 may be press fit into base plate 1002 to raise jam and jelly maker 100 off a surface such as a countertop surface and prevent it from sliding when in use.

Base plate 1002 also includes a plurality of louvers and channeling features, referred to herein as louvers 1006 to allow any liquids that may enter base 1000 to escape. A plurality of base screw bosses 1056 extend upwardly from base plate 1002 and hold base assembly 102 together. Reflector plate 1048 is secured to screw bosses 1056 with Bakelite shims 1058 (also referred to as screw boss caps) therebetween, such as with screws (not shown). Screw boss caps 1058 are disposed in screw bosses 1056. Screw boss caps 1058 are illustratively made of a high temperature material such as high temperature Bakelite and improve the conductive heat resistance of base screw bosses 1056. Screw boss caps 1058 have a geometry that promotes enhanced heat radiation away from the more temperature sensitive base screw bosses 1056. For example, screw boss caps 1058 may have a limited surface area that contacts reflector plate 1048 to reduce heat transfer downwardly into the base screw bosses 1058. Screw boss caps 1058 may also have a louver (or louvers) to dissipate heat.

A cord holder (not shown) is disposed in sidewall 1008 of base housing 1004 and holds a cord (not shown) that is used to connect jam and jelly maker 100 to an electrical source such as a wall socket.

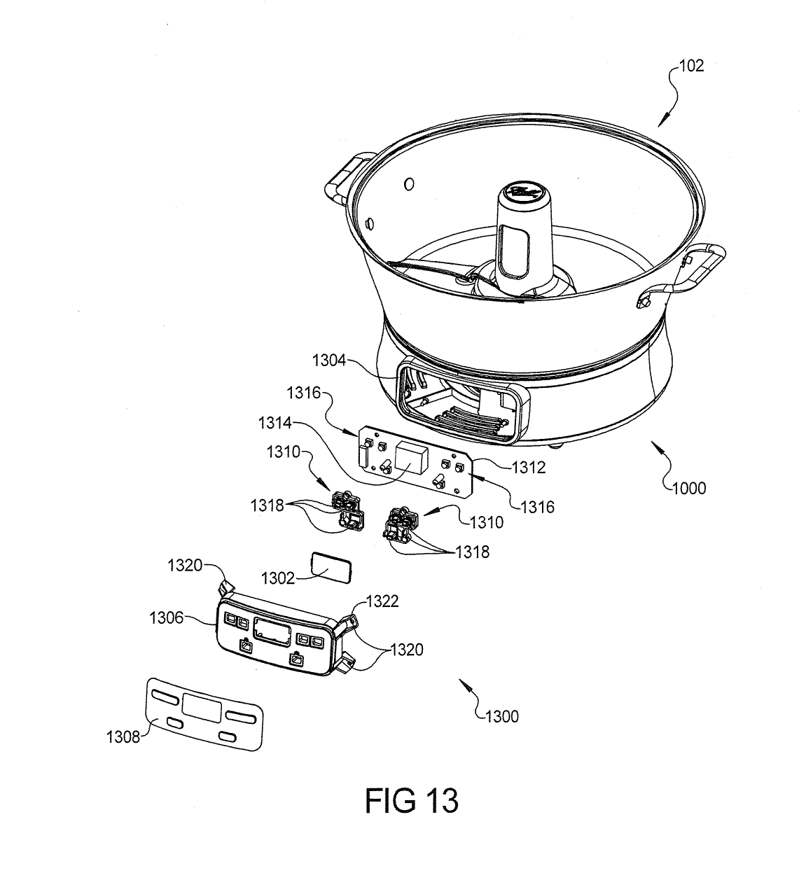

Control module 1064 is mounted to and within a bracket 1066 that is mounted to reflector plate 1048 through a plurality of the screw boss caps 1058 that also act as cooling spacers. Control module 1064 includes electronic components devices and circuitry for controlling jam and jelly maker 100 including power switching devices (not shown) for switching electrical power to heater subassembly 1020 and motor 1010. Control module 1064 may include a controller 1067 programmed with software that controls the operation of jam and jelly maker 100 described in more detail below. Controller 1067 may illustratively be a microcontroller, and may also be other devices such as microprocessors, microcomputers, ASIC's, discrete logic or the like. Control module 1064 is coupled to a control module 1312 (FIG. 13) of user interface assembly 1300.

Base assembly 102 also includes a fuse holder (not shown) that holds a fuse (not shown) for electrical overload protection.

Base coupler 1036 surrounds motor shaft 1012 and motor shaft sleeve 1014. Base coupler 1036 includes a cylindrical hub 1076 and annular base flange 1078. Cylindrical hub 1076 extends upwardly from base flange 1078. An upper end 1080 of cylindrical hub 1076 of base coupler 1036 is formed to have upwardly extending opposed ears 1082 on opposite sides of cylindrical hub 1076 with opposed gaps 1084 therebetween that separate opposed ears 1082. Ears 1082 may illustratively be acruate sections of cylindrical hub 1076 at upper end 1080 and have a triangular shape with a truncated top. Base coupler 1036 may illustratively be a cast aluminum part. As discussed above, base coupler mates with pot coupler 836 of pot assembly 104. The geometry of each coupler 836, 1036 helps the user align the pot 800 onto the base 1000 with ease. In the above described embodiment, this geometry includes the ear slots 842 pot coupler 836 and the ears of base coupler 1036 which are received in ear slots 642 of pot coupler 836 pot 800 is lowered onto base 1000. When lowering the pot 800 onto the base assembly 1000, the user can be horizontally off along with angular misalignment while still successfully aligning the pot 800 on the base assembly 1000. Once fully seated both couplers 636, 874 self-align to prevent side to side and rotational movement during the operation of jam and jelly maker 100.

Base assembly 102 also includes a user interface 1300, referred to herein as UI 1300, as shown in more detail in FIG. 13. UI 1300 provides the physical interaction between the user and jam and jelly maker 100. The goal of this interaction between the user and jam and jelly maker 100 at UI 100 is the effective operation and control of jam and jelly maker 100 and feedback which aids the user in making operational decisions.

UI 1300 includes lens cover 1302, outer shell 1304, control box 1306, membrane 1308, button brackets (left and right) 1310 and control module 1312, which may be a printed circuit board assembly. Control module 1312 includes the electrical and electronic components of UI 1300. These components include digital display 1314, push button switches 1316 and memory 1317 (FIG. 15). Outer shell 1304 is the primary structural component of UI 1300 and provides a housing for the other components of UI 1300. It should be understood that outer shell 1304 may be formed as part of base housing 1004. Control module 1312 is received in outer shell 1304. Button brackets 1310 are received on control module 1312 over push buttons 1316. Button brackets 1310 are elastic components with spring back push button actuators 1318, allowing depression of push button switches 1316 via membrane 1308. Lens 1302 is received on control module 1312 over digital display 1314 and protects digital display 1314. Control box 1306 is received in outer shell 1304 over lens 1302, push button brackets 1310 and control module 1312 and affixed to base 800. Control box 1306 is the secondary structural component of UI 1300. Control box 1306 secures both left and right button brackets 1310 to ensure button depression linearity, shielding of the control module 1312 from impact and to provide depression reinforcement for the membrane.

Control box 1306 illustratively includes mounting brackets 1320, illustratively at its four corners, having fastener holes 1322 therein. Fasteners (not show) such as rivets or screws, are inserted through fastener holes 1322 to affix control box 1306 to base 1000. Membrane 1308 is affixed to an outer surface 1324 of control box 1306. Membrane 1308 is a protective cover with text and graphics for use as a location medium when a user is depressing push button switches 1316 of control module 1312.

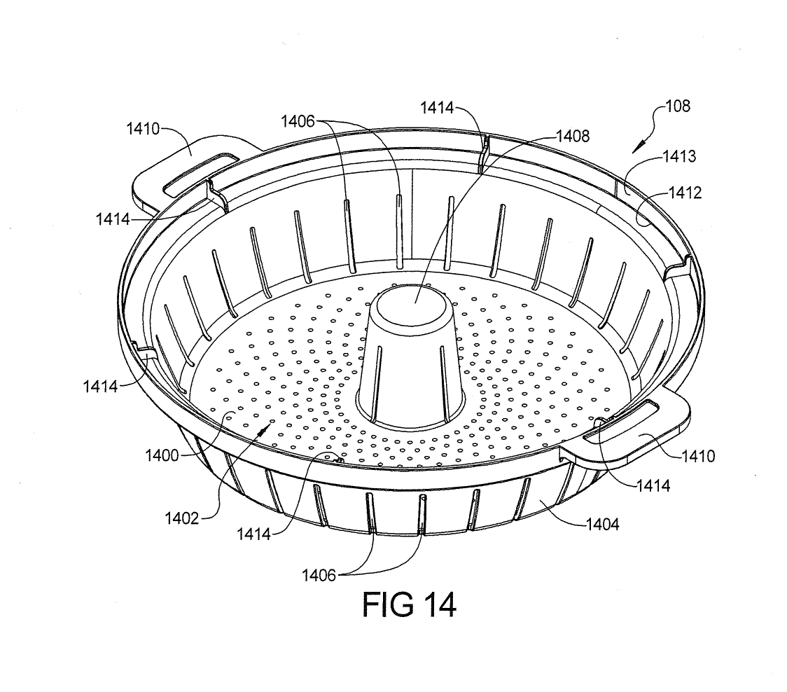

With reference to FIG. 14, colander 108 is pot shaped to conform to pot 800. Colander 108 includes a base 1400 having a plurality of small vent holes 1402. Vent holes 1402 are sufficiently small to prevent seeds of food stuffs such as fruits used to make jams from escaping. Colander 108 further includes a cylindrical sidewall 1404 extending upwardly from base 1400 having a plurality of vertical vent slots therein that allow steam to escape. Colander 108 also includes a pot center post cone cover 1408 shaped to conform to center post cone 826 of pot assembly 104. Pot center post cone cover 1408 provides both a protective cover for center post cone 826 of pot assembly 104 when colander 108 is received in pot 800 and a mating feature for mating with center post cone 826. Colander 108 also includes opposed handles 1410, which are also long reach handles. A top 1412 of sidewall 1204 includes a lid retainer lip 1206 extending outwardly and upwardly around the periphery of top 1412 of sidewall 1404. A plurality of lid vent ribs 1414 are disposed around lid retainer lip 1206. The embodiment shown in FIG. 14 has four such lid vent ribs spaced equidistantly around lid retainer lip 1406. Lid retainer lip 1406 can have other than four lid vent ribs, such as six lid vent ribs.

FIG. 15 is a simplified schematic showing the interconnection of control module 1064, control module 1312 of UI 1300, motor 1010, heater coil 1026, NTC sensor 1040 and thermostat 1068.

In accordance with this disclosure, automatic jam and jelly maker 100 simplifies the process of making jams and jellies with an automated process. The automatic jam and jelly maker 100, which may be a countertop appliance, converts attended time at the stove to unattended or free time. A user simply plugs in jam and jelly maker 100 device, adds ingredients to the pot 600 of jam and jelly maker 100, and selects the mode/time for the desired recipe. The automatic jam and jelly maker 100 heats and stirs ingredients to the optimal consistency based on proven recipes.

By removing a person from the stove during jam and jelly making, hands-on time is decreased as automatic heating and stirring features accomplish what was once done manually. Those who want to control the quality of their jams and jellies by making them from scratch, yet are intimidated by this task, can now do so with confidence. By a user simply pushing a few buttons, the automatic jam and jelly maker 100 will heat ingredients to the ideal temperature, keep the contents moving for a specified amount of time and shut down automatically at the end of the cooking cycle. Even veteran jam and jelly makers will appreciate this device for its overall convenience and ease of use.

Compared to other conventional jam and jelly makers, the jam and jelly maker 100 described above is lower in overall height and has a larger pot diameter to improve evaporation during jam making. This wider overall diameter promotes a shorter cook time. Base 802 of pot 800 (FIG. 8) has a curved bottom to improve its strength whereas other units have a flat pot base. The curved bottom of the pot base 802 also improves the effectiveness of the stirrer as discussed above and below. The glass cover 300 of jam and jelly maker 100 is improved over the polycarbonate plastic lid of other appliances. The lid assembly 110 has vent holes 314 around the outside of the lid ring 302 whereas others vent steam at the top of the lid. This positioning of the vent holes 314 around the outside of the lid ring 302 improves the overall heat efficiency of the pot and provides ample condensation for fruit extraction during steaming.

The coupling provided by pot coupler 836 and base coupler 1036 couples and centers the pot 800 onto the heater plate 1022 of base assembly 102. This coupling is much more forgiving than those on other units, which use a plastic skirt to center the pot onto the base. The heater plate 1022 of base assembly 102 described above is fixed to the base 1000 of base assembly 102 of jam and jelly maker 100 whereas the heater of other jam and jelly makers is fixed to the pot making cleaning the pot far more difficult as the user now has to carefully hand wash the pot. The user interface 100 of jam and jelly maker 100 is easier to use and the digital display 1314 easier to read than other conventional appliances.

Automatic jam and jelly maker 100 has a cook mode which further has a jam mode and a jelly mode. In a variation, jam and jelly maker 100 may also have a steam mode. The jam and jelly modes are cook modes and used to make jam and jelly. The steam mode is used to extract the natural juice contained within fruits before making jelly. To understand the purpose of the features and functions built into jam and jelly maker 100 for making jam and jelly it is first important to understand how jams and jellies are made with sugar, pectin, juice and/or fruit, heat and time. A brief overview of a popular recipe for strawberry jam is discussed below. The jam and jelly modes do not require use of the colander 108. The lid assembly 110 is used in the jam mode but not the jelly mode. The lid assembly 110 is also used in the steam mode as is the colander 108.

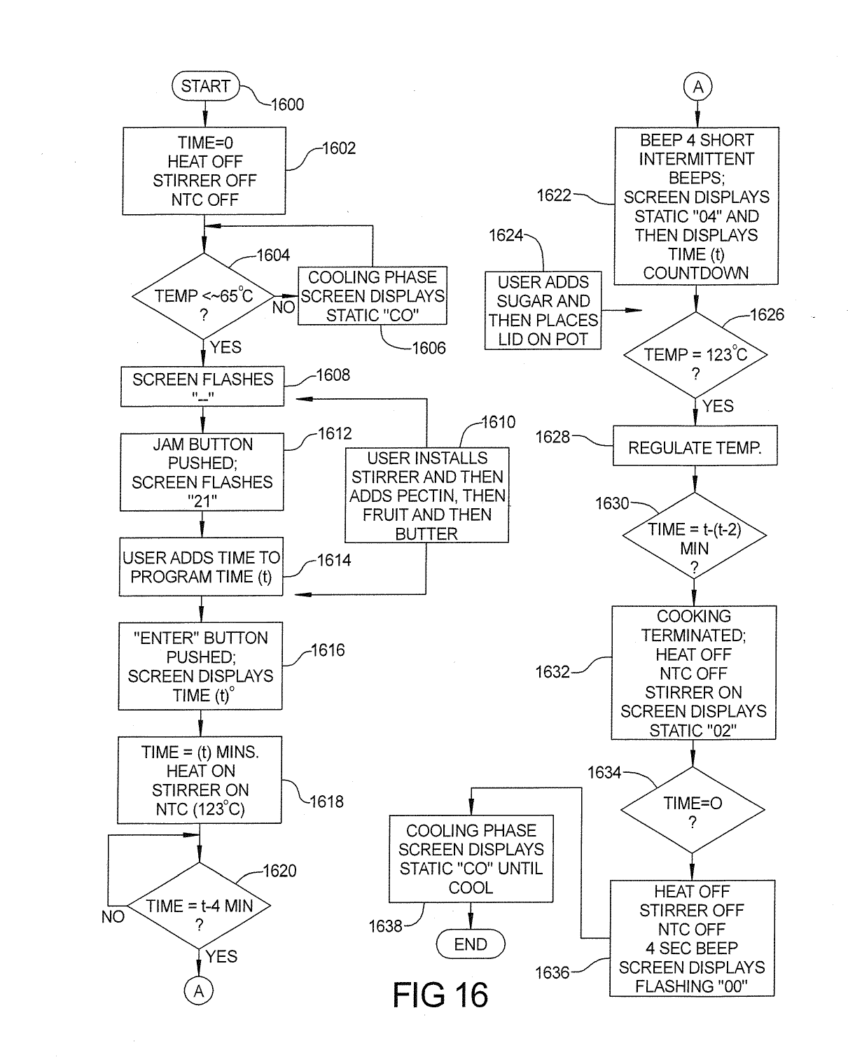

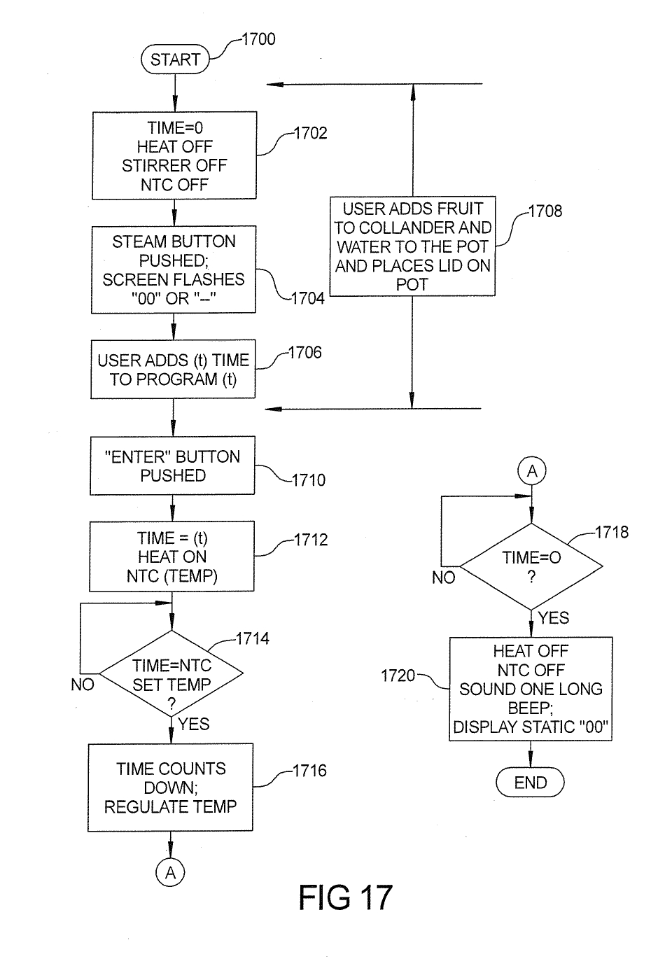

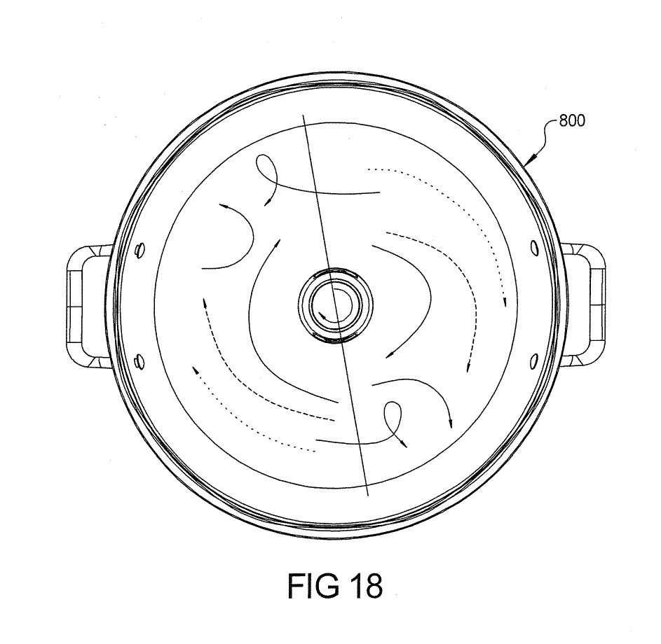

The program logic for the jam mode is set out in Table 1 below and also shown in FIG. 16. The program logic for the jelly mode is set out in Table 2 below and is also shown in FIG. 17. The program logic for the steam mode is set out in Table 3 below and is also shown in FIG. 18. The program logic for the jam, jelly and steam modes may illustratively be programmed in software executed by controller 1067 of control module 1064 of base assembly 102. This software may illustratively be stored in memory 1317 of control module 1312 of UI 1300. It should be understood that UI 1300 could include controller 1067 instead of (or in addition to) control module 1064. It should also be understood that control module 1064 could include memory 1317 instead of (or in addition) to control module 1312.

The operation of jam and jelly maker 100 to make strawberry jam is described with reference to Table 1 and FIG. 16 using a popular recipe for strawberry jam.

TABLE 1
Logic for Jam Mode
Process Control for the “Jam” Mode

| Time | | | NTC | Time | | |
|---|---|---|---|---|---|---|
| (minutes) | Action | Heat | Temp | ON/OFF | Stirrer | UI display |
| 0 | Device is plugged in & turns on | OFF | OFF | OFF | OFF | |
| | automatically | | | | | |
| | Program checks NTC Temperature | | | | | |
| | Immediately | | | | | |
| | >NTC Temperature cool? (<~65° C.) | | | | | Flashes “--” |
| | Proceed to program | | | | | |
| | >NTC Temperature too hot? | | | | | Static “CO” |
| | (>~65° C.) Cooling Phase until OK | | | | | displayed until cool |
| | User installs stirrer to conical | | | | | Flashes “--” |
| | structure of pot | | | | | |
| | User adds pectin first | | | | | |
| | User adds fruit second | | | | | |
| | User adds butter third | | | | | |
| | User places lid so that is at hand, | | | | | |
| | such as such as next to the device, | | | | | |
| | until needed - JAMS ONLY, NOT | | | | | |
| | JELLIES | | | | | |
| | Program “Jam” button pushed | | | | | Flashes “21” |
| | User adds/subtracts time in | OFF | OFF | OFF | OFF | Flashing time “t” |
| | increments of 1 minutes (“+” or “−”) | | | | | |
| | to program “t”. A total of +10 | | | | | |
| | or −10 minutes can be inputted. | | | | | |
| | Example = 21 + 9 = 30 OR 21 − 11 = 10 | | | | | |
| | User pushes “Enter” button | ON | 7B | 8 sec | ON | Static display time |
| 0 to 3:59 | Pectin, fruit & butter incorporated | | (123° C.) | ON/2 | | “t” countdown |
| | via stirrer | | | sec OFF | | |
| 4 | Jammer beeps 4 small | | | | | Static “04” |
| | intermittent beeps (lasting 1 | | | | | Displayed |
| | second each) | | | | | |
| 4 to 6 | User adds sugar gradually with | | | | | Static display time |
| | stirrer running and then places lid | | | | | (t) countdown |
| | onto pot (jams only) | | | | | |
| 4 to (t − 2) | Program continues without any | | | | | |
| | user interaction | | | | | |
| t − 2 | Heat stops (unnoticed by user), | OFF | OFF | OFF | ON | Static “02” |
| | stirrer continues | | | | | displayed |
| t = 0 or EOP | Device beeps one long beep (lasts | OFF | OFF | OFF | OFF | Flashing “00” |
| | 4 seconds) | | | | | displayed |
| 3 Minutes | Initiate cooling phase - Lasts until | OFF | OFF | OFF | OFF | Static “CO” |
| after EOP | NTC is cool | | | | | displayed until cool |

Notes:
“t” = total time for the entire process to complete includes 4 minutes pectin incorporation and 2 minutes heat off & stirring at the end
t − 2 = a function that represents minus 2 minutes from the end of the total cycle time “t”
At any stage the user can push the “enter” button to change the direction of the motor/stirrer
At any stage the user can push the “cancel” button to (1) terminate the program and (2) terminate machine set points (time, cook or steam function).
EOP—End of program
CO—Cooling or “OFF” phase determined by PAL to prevent user from starting another cycle before the machine properly cools - Prevents machine overheating over multiple cycles
Error Messages
“E1” - There is only 1 error message. “E1” represents any overheating, dry pot or excessive temperatures picked up from the thermostat. This message is displayed on screen and is called out in the user manual. The user has to reset the machine by pushing cancel and allowing the unit to cool to normal temperatures before it can be used again.
Time limits
As soon as the user enters the “jam” function, the jammer machine must display the time, “21” minutes. The user than has the ability to add 9 or subtract 11 minutes only. This means that the minimum allowable time displayed on screen is “10” minutes and the maximum time is “30” minutes for the “jam” function.

Since the jam mode will be used, stirrer assembly 106 is placed in pot 800. It should be understood that the operation of jam and jelly maker 100 is controlled by control module 1064, with for example controller 1067 programmed with software implementing the below described logic.

Strawberry jam is a combination of fruit, sugar and pectin ingredients which are exposed to heat and agitation over time to create a viscous blend of spreadable fruit and jell. The first step in making jam is to prepare the fruit. It's important for the user to measure the necessary quantity of fruit, per a recipe instruction, to ensure the recipe outcome is satisfactory. To prepare the strawberries for jam, the user is required to mash and/or crush the strawberries into finer pieces all the while releasing much of the natural juice held captive within the body of the fruit.

At 1600, the user turns on automatic jam and jelly maker 100. This can be done simply by plugging the electrical cord into a standard two or three prong electrical outlet as the machine may or may not have a power button. When jam and jelly maker 100 is first turned on, at 1602 a set cook time is at zero and heater coil 1026, motor 1010 and NTC 1040 are all off. At 1604, the program checks whether the temperature sensed by NTC sensor 1040 is too hot, for example greater than a predetermined high temperature limit such as 65° C. If the temperature is too hot, the program branches to a cooling phase and at 1606 displays “CO” on UI 1300 at 1606 until the temperature has fallen below the predetermined high temperature. In this regard, the program will not recognize the user pressing a mode button on UI 1300 until the temperature has fallen below the predetermined high temperature limit.

If at 1604 the temperature sensed by NTC sensor is below the predetermined high temperature limit, the program proceeds to 1608 where it prompts the user to select a mode by displaying “- -” on UI 1300. This also prompts the user to install the stirrer assembly 106 in pot 800 and add, the pectin powder, fruit and butter (in that order) to the pot, which the user does so at 1610. At 1610, the user now selects the Jam mode by pressing the “Jam” button on UI 1300. The program then displays “21” on UI 1300 to acknowledge that the Jam button has been pressed. Once the Jam mode is activated, at 1614 the user inputs a set cook time via +/− input keys on the UI 1300 (FIG. 13). Each recipe has an appropriate cook time which requires manual input from the user.

Once the set cook time is input and the pectin powder, fruit and butter have been added, the user then confirms the set cook time is accurate and at 1616 starts the program by pressing the “enter” button on UI 1300 (one and the same task). It should be understood that the fruit/pectin can be added to pot 800 at any point after the NTC sensor 1040 has sensed that the temperature has fallen below the predetermined high temperature limit and before the user presses the “enter” button. Once the user has pressed the “enter” button, jam and jelly maker 100 becomes activated and begins executing against the program settings for the Jam mode. At 1618, the cook time begins counting down, the heater coil 1026 and the motor 1010 are turned on and the NTC sensor 1040 is set to a set point of 123° C. In the initial phase of program execution, motor 1010 is rotated to rotate the blades 510 of stirrer assembly 106 while the heater coil 1026 is energized to increase the temperature of the heater plate 1022. The heater plate 1022 in turn conducts this heat directly into the bottom of the pot 800. This process will continue for an initial predetermined time period, such as four minutes. It should be understood that the initial predetermined time period can be other than four minutes. During this time the stirrer blades 510 work the pectin powder into the fruit and/or juice and allow a bond to generate between the two ingredients. Prematurely adding sugar will compromise the recipe as sugar interrupts and prevents this pectin-to-fruit bonding. At 1620, the program checks whether the initial predetermined time period has passed. If not, it loops back to 1620.

Once the initial predetermined time period passes, the program proceeds to 1622 where it causes jam and jelly maker 100 to alert the user, such as via a beep (or beeps) and visual flashing, that it is time to add sugar. At 1624, the user slowly adds sugar to the pot and after doing so, places lid assembly 110 on pot 800. As sugar is slowly added to the pot, the user may notice that the stirrer blade design promotes a churning effect that rolls, blends and turns over the bottom layer of food mix to incorporate ingredients much faster than conventional methods. Meanwhile the temperature of heater plate 1022 has increased enough to begin melting the sugar. The combination of juice release from the fruit plus the melted sugar makes for a homogenous blend of liquid and solid ingredients throughout the pot. The actual cook time continues to count down with heater coil 1026 and motor 1010 remaining on and the NTC set point remaining at 123° C.

Approaching program minutes 11-20, a full rolling boil is ramping up. It is during this time the cook mode setting reaches its full temperature value. The cook mode is programmed to 123° C. Once the program at 1626 determines that this temperature has been detected by NTC sensor 1040, the program at 1628 then regulates the temperature with control module 1064 turning heater coil 1026 on and off by turning relay 1027 on and off. Illustratively, heater coil 1026 is turned on and off in ten second cycles with heater coil 1026 being on for 8 second and then off for two second.

At 13 to 15 minutes into the program, a steady boil is taking place and the batch of ingredients in pot 800 is off gassing. It is also common at this time to notice foam collecting at the top of the mix. This foam can be reduced or eliminated in two ways. The first way is during the initial phase of program execution, where butter or margarine can be added to the batch. The second way is to collect and remove the foam at the end of the program by surface skimming. For option one, the addition of butter or margarine decreases the surface tension of liquids within the mix and therefore makes it harder for foam to develop. The stirrer blades 504 have a geometry that creates a centrifugal action pushing the foam to collect at the outer wall of the pot 800. This makes removing the foam much easier on the user if butter is not preferred. It is important during this period for the lid assembly 110 to be off the pot 800 as evaporation is critical to the successful outcome of the jam and jelly set.

Further into the program at around 13-15 minutes, the geometry of stirrer blades 504 exhibits its capability to homogeneously mix constituents and prevent food particles from burning on the bottom of the pot 800. With many conventional blade designs, it is difficult to agitate food particles near the center hub as these particles are trapped and/or unable to break away from the tow of the circulating batch.

The geometry of stirrer blades 504 is a double airfoil helix geometry which draws food near the bottom of the pot and turns it over. This double-acting agitation helps to ensure full mixing of the ingredients in pot 600 during operation of jam and jelly maker 100 in the cook mode. The arrows in FIG. 18 illustrates flow patterns in the mix of ingredients in pot 600 when the stirrer blades 504 rotate clockwise.

As discussed, base 802 of pot 800 is convex (when viewed from the perspective of looking down into pot 800). This convex shape works with gravity to pull the bulk of food mass to the lowest point near the outer circumference of the pot 600. The combination of this convex geometry of base 802 of pot 800 coupled with the geometry of stirrer blades 504 provides a double acting agitating motion to better incorporate ingredients during operation of jam and jelly maker 100 in the cook mode and prevent food trapping and burning.

At 1630, the program checks whether the actual cook time has counted down to two minutes of the set cook time (i.e., two minutes are left in the cook cycle). This will be approximately 21 minutes (depending on the recipe). If not, control module 1064 loops back to 1630. If the actual cook time has counted down to two minutes of the set cook time, at 1632 the cook cycle is terminated.

When the cook cycle is terminated at 1632, heater coil 1026 and NTC sensor 1040 are turned off and motor 1010 remains running. During this non-heated agitation cycle, the stirrer assembly 106 continues agitating to ensure residual heat does not burn static food particulates at the bottom of the pot 800. This non-heated agitation cycle goes on for approximately two minutes. At 1634 the program checks whether the programmed time has reached zero. If not, control module loops back to 1634. Once this time is up (which may for example be approximately 23 minutes into the program), at 1636 the program alerts the user (such as via a beep) that the program is complete, and turns motor 1010 off (with heater coil 1026 and NTC sensor 1040 remaining off). The user should then immediately transfer the jam into containers for preservation. It may also be required at this point to ladle off any remaining foam accumulated during processing. The program then proceeds at 1638 to a cooling cycle (also referred to as a cooling phase) that lasts until the temperature sensed by NTC sensor 1040 is below the predetermined high temperature limit, which may be approximately 65° C. as discussed above. During this cooling cycle, the program displays “CO” on UI 1300 and the program will not respond to a mode button being pressed on UI 1300 disabling the starting of any mode anew, such as the cook mode (Jam or Jelly mode), or the steam mode.

The operation of jam and jelly maker 100 to make jelly is described with reference to Table 2. The Jelly mode is very similar to the Jam mode, so the following discussion will thus focus on the differences.

TABLE 2
Logic for Jelly Mode
Process Control for the “Jelly” Mode

| Time | | | NTC | Time | | |
|---|---|---|---|---|---|---|
| (minutes) | Action | Heat | Temp | ON/OFF | Stirrer | UI display |
| 0 | Device is plugged in & turns on | OFF | OFF | OFF | OFF | |
| | automatically | | | | | |
| | Program checks NTC Temperature | | | | | |
| | Immediately | | | | | |
| | >NTC Temperature cool? (<~65° C.) | | | | | Flashes “--” |
| | Proceed to program | | | | | |
| | >NTC Temperature too hot? | | | | | Static “CO” |
| | (>~65° C.) Cooling Phase until OK | | | | | displayed until cool |
| | User installs stirrer to conical | | | | | Flashes “--” |
| | structure of pot | | | | | |
| | User adds pectin first | | | | | |
| | User adds juice second | | | | | |
| | User adds butter third | | | | | |
| | Program ‘“Jelly” button pushed | | | | | Flashes “25” |
| | User adds/subtracts time in | OFF | OFF | OFF | OFF | Flashing time “t” |
| | increments of 1 minutes (“+” or “−”) | | | | | |
| | to program “t”. A total of +5 | | | | | |
| | or −15 minutes can be inputted. | | | | | |
| | Example = 25 + 5 = 30 OR 25 − 15 = 10 | | | | | |
| | User pushes “Enter” button | ON | 7B | 8 ON/2 | ON | Static display time |
| 0 to 3:59 | Pectin & butter incorporated via | | (123 C.) | OFF | | “t” countdown |
| | stirrer | | | | | |
| 4 | Device beeps 4 small intermittent | | | | | Static “04” |
| | beeps (lasting 1 second each) | | | | | Displayed |
| 4 to 6 | User adds sugar gradually with | | | | | Static display time |
| | stirrer running | | | | | (t) countdown |
| 4 to (t − 2) | Program continues without any | | | | | |
| | user interaction | | | | | |
| t − 2 | Heat stops (unnoticed by user), | OFF | OFF | OFF | ON | Static “02” |
| | stirrer continues | | | | | displayed |
| t = 0 or EOP | Device beeps one long beep (lasts | OFF | OFF | OFF | OFF | Flashing “00” |
| | 4 seconds) | | | | | displayed |
| 3 Minutes | Initiate cooling phase - Lasts until | OFF | OFF | OFF | OFF | Static “CO” |
| after EOP | NTC is cool | | | | | displayed until cool |

Notes:
“t” = total time for the entire process to complete includes 4 minutes pectin incorporation and 2 minutes heat off & stirring at the end
t − 2 = a function that represents minus 2 minutes from the end of the total cycle time “t”
At any stage the user can push the “enter” button to change the direction of the motor/stirrer
At any stage the user can push the “cancel” button to (1) terminate the program and (2) terminate machine set points (time, cook or steam function).
EOP—End of program
CO—Cooling or “OFF” phase determined by PAL to prevent user from starting another cycle before the machine properly cools - Prevents machine overheating over multiple cycles
Error Messages
“E1” - There is only 1 error message. “E1” represents any overheating, dry pot or excessive temperatures picked up from the thermostat. This message is displayed on screen and is called out in the user manual. The user has to reset the machine by pushing cancel and allowing the unit to cool to normal temperatures before it can be used again.
Time limits
As soon as the user enters the “jelly” function, the jammer machine must display the time, “25” minutes. The user than has the ability to add 5 or subtract 15 minutes only. This means that the minimum allowable time displayed on screen is “10” minutes and the maximum time is “30” minutes for the “jelly” function.

In the Jelly mode, at 1610, the user adds fruit juice instead of fruit to the pot. At 1612, “25” is flashed on the screen of UI 1300 instead of “21.” At 1614, a total of +5 minutes or −15 minutes can be inputted instead of +10 minutes or −10 minutes. At 1624, the lid assembly is not placed on pot 800.

As mentioned above, in a variation, automatic jam and jelly maker also has a steam mode that is used to extract the natural juice contained within fruits for making jelly. This extracted use is then used such as in the cook mode of jam and jelly maker 100 to make jellies from the juice, with the addition of sugar, pectin, heat and time. Both the colander 108 and lid assembly 110 are required to be used during operation of jam and jelly maker 100 in the steam mode. Strawberry jelly is a combination of fruit juice, sugar and pectin ingredients which are exposed to heat over time to create a viscous blend of spreadable gel. To prepare the strawberries for jelly the user is required to place them in a steam bath to release the natural juice held captive within the body of the fruit. Strawberries can be cut into halves or quarters to improve the release of juice.

The operation of jam and jelly maker 100 in the steam mode is described with reference to Table 3 and FIG. 17, with reference to extracting juice from strawberries.

TABLE 3
Logic for Steam Mode
Process Control for the “Steam” Mode

| Time | Action | Heat | NTC | Stirrer | UI display |
|---|---|---|---|---|---|
| 0 Mins | Device is plugged in | OFF | OFF | OFF | Flashes “—” |
| | User adds fruit to strainer, | | | | |
| | water to the pot, Lid ON | | | | |
| | TOP (NO Stirrer) | | | | |
| | “Steam” button pushed | | | | Flashes “00” |
| | User adds time (“+”) to | | | | Static time “t” |
| | program (t) | | | | |
| | User pushes “Enter” | ON | TBC | ON | Static display time |
| t to 0 mins | Program continues without | | | | (t: countdown) |
| | any interaction or | | | | |
| | disturbances. When | | | | |
| | TEMP reaches the NTC | | | | |
| | setting, TEMP is | | | | |
| | regulated. | | | | |
| Time 0 (END) | Machine beeps one long | OFF | OFF | OFF | Static “00” |
| | beep | | | | displayed |

Notes:
(1) t = total time for the entire process to complete (user inputted time)
(2) At any stage the user can push and hold down the “Cancel” button to terminate the program.

If still in the “cook” mode (Jam or Jelly), the user will need to remove the stirrer assembly 106 from the pot 800 by firmly pulling up on the center hub 506 of stirrer assembly 106. This will release the stirrer drive shaft 504 from the motor shaft sleeve 814 and allow the stirrer assembly 106 to detach from pot assembly 102. Once the stirrer assembly 106 is removed, the user places colander 108 into the pot 800. Colander 108 is shaped to nest within the base housing side wall 1008 and conical pot 800. With the colander 108 in place, the user pours a predetermined quantity of water, per a recipe instruction, directly through the colander 108. The water sieves through the base vent holes 1402 of base 1400 of colander 108 and drips into the bottom of the pot 800. This water is used to steam the fruit. The user should pour water through the colander 108 rather than directly into the pot 800 (absent the colander 108) to avoid accidental water spillage into an opening in the top of center post cone 816 of pot assembly 104. Once all water has reached the bottom of the pot 800, the user adds cut strawberries evenly throughout the colander 108. The user then places lid assembly 110 atop the colander 108 (which nest together) ensuring the lid vent holes 314 are visible and good ventilation can easily be achieved.

At 1700, the user turns on jam and jelly maker 100. This can be done simply by plugging an electrical cord into a standard two or three prong electrical outlet as the machine may or may not have a power button. At 1702, a set steam time is at zero, and heater coil 1026, motor 1010 and NTC sensor 1040 are off. Once jam and jelly maker is plugged in, the user activates the required mode 1704. In this case, the desired mode is “steam” which again is designed to be used for making juice for jelly and is activated by the user pressing the “steam” button on UI 1300. Once “steam” activated, at 1706 the user inputs a set steam time via +/− input keys on UI 1300. Each recipe has a different required steam time which is manually set or inputted by the user.

Once the set steam time is input and the user has added the water and fruit at 1708 and placed the lid assembly 110 on colander 108, the user confirms that the input set steam time is correct and at 1710 starts the program by pressing the “enter” button on UI 1300 (one and the same task). It should be understood that the water and fruit can be added and lid assembly 110 placed on colander 108 before jam and jelly maker 100 at any point before the “enter” button is pressed.

Once the “enter” button has been pressed, jam and jelly maker 100 becomes activated and begins executing the program settings. During an initial phase of the program at 1710, a NTC temperature is set at a desired temperature in the range of 100° C. to 165° C. (for example, 123° C.) and heater coil 1026 is turned on to increase the temperature of the heater plate 1022 to this set temperature. Motor 1010 remains off during the steam mode since stirrer assembly 106 isn't used. The heater plate in 1022 turn conducts heat directly into the bottom of the pot 800. At 1714, control module 1064 checks whether the temperature sensed by NTC sensor 1040 has reached the set temperature. If not, control module branches back to 1714. Once the see temperature has reached the set temperature, at 1716 the actual steam time begins counting down from the set steam time. Also, the program regulates the temperature with control module 1064 turning heater coil 1026 on and off by turning relay 1027 on and off. Illustratively, heater coil 1026 is turned on and off in ten second cycles with heater coil 1026 being on for 8 second and then off for two second. This process continues for the set steam time (as per recipe instruction), which in many cases is approximately thirty minutes.

During the steaming process when operating jam and jelly maker 100 in the steam mode, the internal temperature of the pot 800 covered with lid assembly 110 exceeds boiling water temperature as steam is created and is injected into the fruit. The steaming process softens the fruit and allows fruit juice to drip down through the base vent holes 1402 in the base 1400 of colander 108 in the bottom of the pot 800. The resulting steam (water vapor) is vented through the lid assembly 110 via lid vent holes 314. It is the goal of this process (heat and time) to evaporate 50% of the original water from the pot 800 and replace it with fruit juice.

At 1718, the program checks whether the actual steam time has reached the set steam time (i.e., counted down to zero). If not, the program branches back to 1718. If so, the initial steam process is complete and the program branches to 1720 where jam and jelly maker 100 alerts a user that the steam process has ended, such as via a beep with UI 1300 and static display of “00” on UI 1300. The user removes lid assembly 110 and removes colander 108 from pot 800 to expose the fruit juice. It is not required nor is it recommended to mash the remaining fruit to expel any additional juice from the remaining fruit solids. The juice is now ready for use for making jelly.

The lid assembly 108 is similar to most standard stock pot lids but with the exception of lid vent holes 314 round the lid ring 302. Each vent hole allows steam to escape during the juicing or “steam” mode. The lid assembly 110 is only used during the steam mode and not used during the cook mode while making jam or jelly. When placed on the pot 800 during a heating cycle, the lid assembly 110 traps a portion of heat to force the temperature up within the pot 800, similar to stove top lid applications. Without the lid assembly in place, the heater coil 1026 alone could not reach a high enough temperature to successfully achieve boiling and streaming of the underlying water. The number and size of the vent holes 314 in lip ring 302 are designed to evaporate 50% of the water as described above while maintaining the temperature of the jam or jelly within the pot at a predetermined temperature, such as 100° C. up to 165° C.

The next step in making jelly is to take the fruit juice extracted during the steam process and add pectin and sugar to promote gelling as discussed above.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

1. An automatic jam and jelly maker, comprising:
a base assembly having a motor, a heater subassembly, a user interface, and a control module;
the heater assembly including a heater plate and a heater coil disposed beneath the heater plate;
a pot assembly removably receivable on the base assembly with a bottom of a pot of the pot assembly resting on the heater plate when the pot assembly is received on the base assembly;
a stirrer assembly removably receivable in the pot of the pot assembly;
the automatic jam and jelly maker having a cook mode in which the stirrer assembly is received in the pot and when the jam and jelly maker is in the cook mode, the control module energizing the motor and heater subassembly to rotate the stirrer assembly to stir ingredients in the pot and to heat the ingredients in the pot for a period of time based on a time settable by the user via the user interface that includes a cook cycle, a non-heated agitation cycle after the cook cycle, and a cool down phase after non-heated agitation phase;
wherein during the cook cycle the motor is turned on by the control module and rotates to rotate the stirrer assembly to stir the ingredients in the pot with the blades of the stirrer assembly rotating through the ingredients and the heater coil is energized by the control module to heat the ingredients in the pot to a predetermined temperature and cycled thereafter to regulate a temperature of the heater coil and thus regulate a temperature of the heater plate;
wherein during the non-heated agitation cycle the heater coil being de-energized by the control module during the non-heated agitation cycle with the motor remaining turned on by the control module to continue stirring the ingredients in the pot with the stirrer assembly; and
wherein during the cool down cycle, the heater coil and motor are de-energized and starting of the cook mode anew is disabled until the cool down cycle is over determined by a temperature sensor of the base assembly abutting a bottom of the pot sensing that a temperature has fallen below a predetermined high temperature limit.

2. (canceled)

3. The automatic jam and jelly maker of claim 1 wherein the control module is responsive to the temperature sensor sensing that the predetermined temperature has been reached and then cycling the heater coil on and off to regulate the temperature of the heater coil.

4. The automatic jam and jelly maker of claim 1 wherein the control module when the automatic jam and jelly maker is in the cook mode alerts the user via the user interface to add sugar to the ingredients in the pot at a predetermined time after the cook cycle has started.

5. The automatic jam and jelly maker of claim 4 wherein the user interface sounds a beep and flashes visually to alert the user to add sugar and the predetermined time at which the control module alerts the user to add sugar is about four minutes after the cook cycle has started.

6. The automatic jam and jelly maker of claim 1 wherein the stirrer assembly includes a central hub with a plurality of stirrer blades extending radially outwardly therefrom, the stirrer blades having a double airfoil helix geometry.

7. The automatic jam and jelly maker of claim 6 wherein the bottom of the pot has a convex geometry that works with gravity to pull a bulk of the ingredients in the pot toward a lowest point in the pot at an outer edge of the pot.

8. The automatic jam and jelly maker of claim 7 wherein when the stirrer assembly is rotating thus rotating the stirrer blades through the ingredients in the pot, the double airfoil helix geometry draws upwardly ingredients near a bottom of the pot, turns the ingredients over and pulls the ingredients toward a center hub of the stirrer assembly.

9. The automatic jam and jelly maker of claim 6 wherein the central hub of the stirrer assembly includes a drive support post having a lower hollow central bore in which an upper portion of a drive shaft is received, a lower portion of the drive shaft received in an upper portion of a motor shaft sleeve of the base assembly, a lower portion of the motor shaft sleeve secured to a motor shaft of a motor of the base assembly.

10. The automatic jam and jelly maker of claim 9 wherein the upper portion of the drive shaft is knurled and the lower portion of the drive shaft is keyed to correspond to a corresponding key of an upper portion of the motor shaft sleeve, the upper portion of the motor shaft sleeve formed with chamfer allowing a loose fit with the drive shaft until the stirrer assembly is fully in place in the pot of the pot assembly.

11. The automatic jam and jelly maker of claim 1 wherein the pot of the pot assembly includes a pot coupler secured to an underside of the bottom of the pot, the base assembly including a base coupler disposed at a center of the base assembly, the pot coupler and base coupler self-align with each other when full fully seated with each other.

12. The automatic jam and jelly maker of claim 11 wherein the pot coupler and base coupler have alignment features having geometries that compensate for horizontal and angular misalignment when the pot is being placed on the base assembly to align the pot on the base assembly.

13. The automatic jam and jelly maker of claim 12 wherein the pot coupler is disk shaped and the base coupler includes a cylindrical hub, the alignment features include the pot coupler having ear slots on opposed sides of a central annular bore and the base coupler having opposed ears at an upper end of the cylindrical hub, wherein the opposed ears of the base coupler are received in the ear slots of the pot coupler when the pot is received on the base assembly and coact with the ear slots to align the pot on the base assembly.

14. The automatic jam and jelly maker of claim 13 wherein the pot assembly includes a center post cone extending upwardly from a center of the pot of the pot assembly.

15. The automatic jam and jelly maker of claim 14 wherein the center post cone includes a center post cone flange secured to a pot base flange with a cup shaped elastomeric gasket disposed therebetween, a top portion of the elastomeric gasket having a plurality of annular concentric ribs projecting upwardly form a top surface and a plurality of annular concentric ribs projecting downwardly from a bottom surface, the top portion further including a central bore and a deflection portion surrounding the central bore, the deflection portion having a plurality of ribs extending inwardly from a surface that contacts the center post cone, the deflection portion configured to deflect upwardly and outwardly around the center post cone when the center post cone is inserted through the central bore.

16. The automatic jam and jelly maker of claim 14 wherein the pot assembly includes a center post cone locating ring fastened into the center post cone at a top thereof, the center pot cone locating ring facilitating alignment of a stirrer drive shaft support post of the stirrer assembly as the stirrer assembly is placed in the pot of the pot assembly and prevents the stirrer assembly from contacting the center post cone during rotation of the stirrer assembly, the center post cone locating ring also providing a mating surface for the colander when the colander is received in the pot.

17. The automatic jam and jelly maker of claim 16 wherein the pot includes a pair of opposed long reach handles extending outwardly therefrom.

18. The automatic jam and jelly maker of claim 17 wherein the pot has a frusto-conical geometry with a sidewall extending upwardly and outwardly from a convex bottom.

19. The automatic jam and jelly maker of claim 1 wherein the heater plate has a geometry conforming to a geometry of a bottom of the pot.

20. The automatic jam and jelly maker of claim 19 wherein the base assembly includes a reflector plate disposed below the heater coil.

21. The automatic jam and jelly maker of claim 20 wherein the base assembly includes a base having a base plate, the base plate having a plurality of vents therein.

22. The automatic jam and jelly maker of claim 1 including a lid assembly removably receivable on the pot, wherein the lid assembly includes an annular cover and a lid ring extending around an outer circumference of the cover, the lid ring having a sidewall extending downwardly from the cover, the sidewall of the lid ring having a plurality of vent holes therein.

23. The automatic jam and jelly maker of claim 22 wherein the lid assembly includes a lid knob secured to a center of the cover, the lid knob having an inverse taper geometry.

24. The automatic jam and jelly maker of claim 1 wherein the cook mode includes a jam mode and a jelly mode that are selectable via the user interface.

25. The automatic jam and jelly maker of claim 1 further having a steam mode in which a colander is received in the pot and a lid assembly is received on a retaining lip of the colander and the control module energizing the heater subassembly to heat ingredients in the pot for a period of time based on a time entered settable by the user via the user interface, the cook and steam modes selectable by a user via the user interface.

26. The automatic jam and jelly maker of claim 25 wherein the lid assembly includes an annular cover and a lid ring extending around an outer circumference of the cover, the lid ring having a sidewall extending downwardly from the cover, the sidewall of the lid ring having a plurality of vent holes therein.

27. The automatic jam and jelly maker of claim 25 wherein the lid assembly includes a lid knob secured to a center of the cover, the lid knob having an inverse taper geometry.

28. The automatic jam and jelly maker of claim 25 wherein the colander has a base having a plurality of vent holes therein.

29. The automatic jam and jelly maker of claim 28 wherein the colander has a sidewall extending upwardly and outwardly from the base of the colander, the sidewall of the colander having a lid retainer lip extending upwardly and outwardly around a periphery of a top of the sidewall of the colander, the lid retainer lip of the sidewall of the colander having a plurality of lid vent ribs spaced therearound.

30. The automatic jam and jelly maker of claim 29 wherein the sidewall of the colander includes a plurality of vertical vent slots therein spaced around the sidewall of the colander.

31. The automatic jam and jelly maker of claim 29 wherein the colander includes a pair of opposed long reach handles extending outwardly from a top edge of the sidewall of the colander.

32. The automatic jam and jelly maker of claim 31 wherein the colander includes a pot center post cone cover shaped to conform to a center post cone of the pot assembly.

33. The automatic jam and jelly maker of claim 25 wherein the cook mode includes a jam mode and a jelly mode that are selectable via the user interface.

34. An automatic jam and jelly maker, comprising:
a base assembly having a motor, a heater subassembly, a user interface, and a control module;
a pot assembly removably receivable on the base assembly with a bottom of a pot of the pot assembly having a convex geometry that works with gravity to pull a bulk of the ingredients in the pot toward a lowest point in the pot at an outer edge of the pot;
a stirrer assembly removably receivable in the pot of the pot assembly, the stirrer assembly includes a central hub with a plurality of stirrer blades extending radially outwardly therefrom, the stirrer blades having a double airfoil helix geometry wherein when the stirrer assembly is rotating thus rotating the stirrer blades through the ingredients in the pot, the double airfoil helix geometry draws upwardly ingredients near a bottom of the pot, turns the ingredients over and pulls the ingredients toward a center hub of the stirrer assembly;
the automatic jam and jelly maker having a cook mode in which the stirrer assembly is received in the pot and when the jam and jelly maker is in the cook mode, the control module energizing the motor and heater subassembly to rotate the stirrer assembly to stir ingredients in the pot and to heat the ingredients in the pot for a period of time based on a time settable by the user via the user interface.

35. The automatic jam and jelly maker of claim 34 wherein the central hub of the stirrer assembly includes a drive support post having a lower hollow central bore in which an upper portion of a drive shaft is received, a lower portion of the drive shaft received in an upper portion of a motor shaft sleeve of the base assembly, a lower portion of the motor shaft sleeve secured to a motor shaft of a motor of the base assembly.

36. The automatic jam and jelly maker of claim 35 wherein the upper portion of the drive shaft is knurled and the lower portion of the drive shaft is keyed to correspond to a corresponding key of an upper portion of the motor shaft sleeve, the upper portion of the motor shaft sleeve formed with chamfer allowing a loose fit with the drive shaft until the stirrer assembly is fully in place in the pot of the pot assembly.

37. An automatic jam and jelly maker, comprising:
a base assembly having a motor, a heater subassembly, a user interface, and a control module;
a pot assembly removably receivable on the base assembly;
the pot of the pot assembly including a pot coupler secured to an underside of the bottom of the pot, the base assembly including a base coupler disposed at a center of the base assembly, the pot coupler and base coupler self-aligning with each other when fully seated with each other;
a stirrer assembly removably receivable in the pot of the pot assembly;
the automatic jam and jelly maker having a cook mode in which the stirrer assembly is received in the pot and when the jam and jelly maker is in the cook mode, the control module energizing the motor and heater subassembly to rotate the stirrer assembly to stir ingredients in the pot and to heat the ingredients in the pot for a period of time based on a time settable by the user via the user interface.

38. The automatic jam and jelly maker of claim 37 wherein the pot coupler and base coupler have alignment features having geometries that compensate for horizontal and angular misalignment when the pot is being placed on the base assembly to align the pot on the base assembly.

39. The automatic jam and jelly maker of claim 38 wherein the pot coupler is disk shaped and the base coupler includes a cylindrical hub, the alignment features include the pot coupler having ear slots on opposed sides of a central annular bore and the base coupler having opposed ears at an upper end of the cylindrical hub, wherein the opposed ears of the base coupler are received in the ear slots of the pot coupler when the pot is received on the base assembly and coact with the ear slots to align the pot on the base assembly.

40. The automatic jam and jelly maker of claim 39 wherein the pot assembly includes a center post cone extending upwardly from a center of the pot of the pot assembly, the center post cone including a center post cone flange secured to a pot base flange with a cup shaped elastomeric gasket disposed therebetween, a top portion of the elastomeric gasket having a plurality of annular concentric ribs projecting upwardly form a top surface and a plurality of annular concentric ribs projecting downwardly from a bottom surface, the top portion further including a central bore and a deflection portion surrounding the central bore, the deflection portion having a plurality of ribs extending inwardly from a surface that contacts the center post cone, the deflection portion configured to deflect upwardly and outwardly around the center post cone when the center post cone is inserted through the central bore.
